(19) United States
(12) Patent Application Publication
(10) Pub. No.: US 2023/0206622 A1
(43) Pub. Date: Jun. 29, 2023

(54) INFORMATION PROCESSING DEVICE, INFORMATION PROCESSING METHOD, AND PROGRAM

(71) Applicant: Sony Group Corporation, Tokyo (JP)

(72) Inventors: Tomohisa TANAKA, Tokyo (JP); Ikuo YAMANO, Tokyo (JP)

(73) Assignee: Sony Group Corporation, Tokyo (JP)

(21) Appl. No.: 18/020,165

(22) PCT Filed: Jul. 20, 2021
(86) PCT No.: PCT/JP2021/027062

§ 371 Date: Feb. 7, 2023

(30) Foreign Application Priority Data
Sep. 25, 2020 (JP) 2020-160333

(51) Int. Cl. G06V 10/94; G06V 10/776; G06V 20/20; G06V 10/80; G06V 40/10; G06F 3/01

(52) U.S. Cl. CPC G06V 10/94; G06V 10/776; G06V 20/20; G06V 10/803; G06V 40/10; G06F 3/014

(57) ABSTRACT

There is provided an information processing capable of robustly recognizing a recognition target while reducing power consumption required for recognition of the recognition target. The information processing device includes: a control unit configured to control switching of an operation unit to be activated between a first operation unit and a second operation unit related to recognition of a recognition target existing in a real space, on the basis of a detection result of a detection target, in which a first sensor configured to obtain first data in which the recognition target is recognized is attached to a first part of a body of a user, and a second sensor configured to obtain second data in which the recognition target is recognized is attached to a second part of the body different from the first part.

### TECHNICAL FIELD

The present disclosure relates to an information processing device, an information processing method, and a program.

### BACKGROUND ART

In recent years, various techniques for recognizing a predetermined recognition target existing in a real space and executing processing according to a recognition result are known. For example, a technique for controlling a virtual object presented on a display worn on a head of a user on the basis of a recognition result of an input device as an example of the recognition target is disclosed (see, for example, Patent Document 1).

### CITATION LIST

### Patent Document

Patent Document 1: Japanese Patent Application Laid-Open No. 2019-46291

### SUMMARY OF THE INVENTION

### Problems to be Solved by the Invention

However, it is desired to provide a technique capable of robustly recognizing a recognition target while reducing power consumption required for recognition of the recognition target.

### Solutions to Problems

According to one aspect of the present disclosure, there is provided an information processing device including: a control unit configured to control switching of an operation unit to be activated between a first operation unit and a second operation unit related to recognition of a recognition target existing in a real space, on the basis of a detection result of a detection target, in which a first sensor configured to obtain first data in which the recognition target is recognized is mounted to a first part of a body of a user, and a second sensor configured to obtain second data in which the recognition target is recognized is mounted to a second part of the body different from the first part.

Furthermore, according to another aspect of the present disclosure, there is provided an information processing method including: controlling, by a processor, switching of an operation unit to be activated between a first operation unit and a second operation unit related to recognition of a recognition target existing in a real space, on the basis of a detection result of a detection target, in which a first sensor configured to obtain first data in which the recognition target is recognized is mounted to a first part of a body of a user, and a second sensor configured to obtain second data in which the recognition target is recognized is mounted to a second part of the body different from the first part.

Furthermore, according to another aspect of the present disclosure, there is provided a program for causing a computer to function as an information processing device including: a control unit configured to control switching of an operation unit to be activated between a first operation unit and a second operation unit related to recognition of a recognition target existing in a real space, on the basis of a detection result of a detection target, in which a first sensor configured to obtain first data in which the recognition target is recognized is mounted to a first part of a body of a user, and a second sensor configured to obtain second data in which the recognition target is recognized is mounted to a second part of the body different from the first part.

### BRIEF DESCRIPTION OF DRAWINGS

FIG. 1 is an explanatory view for explaining an example of a schematic configuration of an information processing system according to an embodiment of the present disclosure.

FIG. 2 is a view illustrating an example of a case where various contents are presented in response to a user's operation input by applying an AR technology.

FIG. 3 is an explanatory view for explaining an example of a schematic configuration of an input/output device.

FIG. 4 is an explanatory view for explaining an example of a schematic configuration of a wearable device.

FIG. 5 is a block diagram illustrating an example of a functional configuration of the information processing system.

FIG. 6 is a view illustrating an example of a depth image.

FIG. 7 is a view illustrating an example of a finger joint position.

FIG. 8 is a view illustrating an example of an image in which each recognized finger joint position is reprojected on a depth image.

FIG. 9 is a view illustrating another example of an image in which each recognized finger joint position is reprojected on a depth image.

FIG. 10 is a view illustrating an example of a field of view of an IR imaging unit of the input/output device.

FIG. 11 is a table in which basic control by an activation control unit is organized for every state.

FIG. 12 is a table in which control by the activation control unit based on reliability is organized for every state.

FIG. 13 is a table in which control by the activation control unit based on reliability on the wearable device side is organized for every state.

FIG. 14 is a table in which an example of integration of control based on reliability on the input/output device side and control based on reliability on the wearable device side is organized for every state.

FIG. 15 is a diagram illustrating an example of a hardware configuration of various information processing devices constituting the information processing system according to an embodiment of the present disclosure.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configuration are denoted by the same reference numerals, and redundant explanations are omitted.

Furthermore, in the present specification and the drawings, a plurality of components having substantially the same or similar functional configurations may be distinguished by attaching different numbers after the same reference numerals. However, in a case where it is not particularly necessary to distinguish each of the plurality of components having substantially the same or similar functional configuration, only the same reference numeral is assigned. Furthermore, similar components of different embodiments may be distinguished by adding different alphabets after the same reference numerals. However, in a case where it is not necessary to particularly distinguish each of the similar components, only the same reference numeral is assigned.

Note that the description will be made in the following order.

1. System configuration

2. Configuration of input/output device

3. Configuration of wearable device

4. Functional configuration of system

5. Reliability of finger joint recognition

6. Notable features

6.1. Basic control

6.2. Control based on reliability on input/output device side

6.3. Control based on reliability on wearable device side

6.4. Control based on reliability of both devices

7. Hardware configuration example

8. Conclusion

### 1. System Configuration

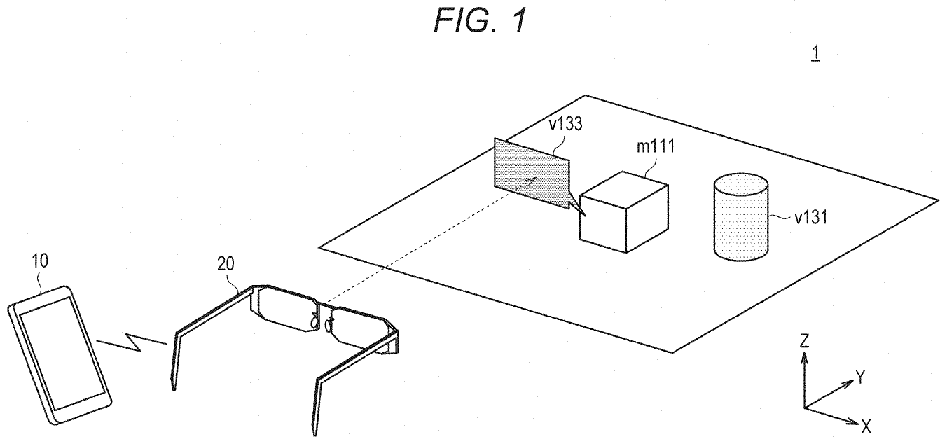

First, an example of a schematic configuration of an information processing system according to an embodiment of the present disclosure will be described with reference to FIG. 1. FIG. 1 is an explanatory view for explaining an example of a schematic configuration of an information processing system according to an embodiment of the present disclosure, and illustrates an example of a case where various contents are presented to a user by applying a so-called augmented reality (AR) technology.

In FIG. 1, a reference numeral m111 schematically indicates an object (for example, a real object) located in a real space. Furthermore, reference numerals v131 and v133 schematically indicate a virtual content (for example, a virtual object) presented so as to be superimposed on the real space. That is, on the basis of the AR technology, for example, an information processing system 1 according to the present embodiment superimposes a virtual object on an object such as the real object m111 in the real space and presents to the user. Note that, in FIG. 1, for easier understanding of features of the information processing system according to the present embodiment, both the real object and the virtual object are presented together.

As illustrated in FIG. 1, the information processing system 1 according to the present embodiment includes an information processing device 10 and an input/output device 20. The information processing device 10 and the input/output device 20 are configured to be able to transmit and receive information to and from each other via a predetermined network. Note that a type of the network connecting the information processing device 10 and the input/output device 20 is not particularly limited. As a specific example, the network may be configured with a so-called wireless network such as a network based on the Wi-Fi (registered trademark) standard. Furthermore, as another example, the network may be configured with the Internet, a dedicated line, a local area network (LAN), a wide area network (WAN), or the like. Furthermore, the network may include a plurality of networks, and at least a part thereof may be configured as a wired network.

The input/output device 20 is a configuration to acquire various types of input information and present various types of output information to a user who holds the input/output device 20. Furthermore, the presentation of the output information by the input/output device 20 is controlled by the information processing device 10 on the basis of the input information acquired by the input/output device 20. For example, the input/output device 20 acquires information (for example, a captured image of a real space) for recognizing the real object m111 as the input information, and outputs the acquired information to the information processing device 10. The information processing device 10 recognizes a position of the real object mill in the real space on the basis of the information acquired from the input/output device 20, and controls the input/output device 20 to present the virtual objects v131 and v133 on the basis of the recognition result. Such control allows the input/output device 20 to present the virtual objects v131 and v133 to the user such that the virtual objects v131 and v133 are superimposed on the real object m111, on the basis of a so-called AR technology.

Furthermore, the input/output device 20 is configured as, for example, a so-called head-mounted device that is used by being worn on at least a part of the head by the user, and may be configured to be able to detect a user's line-of-sight. On the basis of such a configuration, in a case where the information processing device 10 recognizes that the user is gazing at a desired object (for example, the real object m111, the virtual objects v131 and v133, and the like), for example, on the basis of a detection result of the user's line-of-sight obtained by the input/output device 20, the information processing device 10 may specify a target as an operation target. Furthermore, the information processing device 10 may specify a target to which the user's line-of-sight is directed as an operation target, by using a predetermined operation on the input/output device 20 as a trigger. As described above, the information processing device 10 may provide various services to the user via the input/output device 20 by specifying an operation target and executing processing associated with the operation target.

The information processing device 10 recognizes a motion (for example, a change in position and direction, a gesture, or the like) of a position/orientation of an arm, a palm, and a finger joint of the user as a user's operation input on the basis of input information acquired by the input/output device 20, and executes various processes according to a recognition result of the operation input. As a specific example, the input/output device 20 acquires information (for example, a captured image of a hand) for recognizing an arm, a palm, and a finger joint of the user as the input information, and outputs the acquired information to the information processing device 10. The information processing device 10 estimates a position/orientation of the arm, the palm, and the finger joint on the basis of the information acquired from the input/output device 20 to recognize a motion thereof (for example, a gesture), and recognizes an instruction (that is, a user's operation input) from the user in accordance with a recognition result of the motion. Then, the information processing device 10 may control, for example, display of the virtual object (for example, a display position and orientation of the virtual object) to be presented to the user in accordance with a recognition result of the user's operation input. Note that, in the present disclosure, the “user's operation input” may be regarded as an input corresponding to an instruction from the user as described above, in other words, an input reflecting an intention of the user. Hereinafter, the “user's operation input” may be simply referred to as a “user input”.

Furthermore, the information processing device 10 may recognize a motion (for example, a change in position and orientation, a gesture, or the like) of at least a part of the body of the user other than the hand as the user's operation input on the basis of the input information acquired by the input/output device 20, and execute various processes according to a recognition result of the operation input.

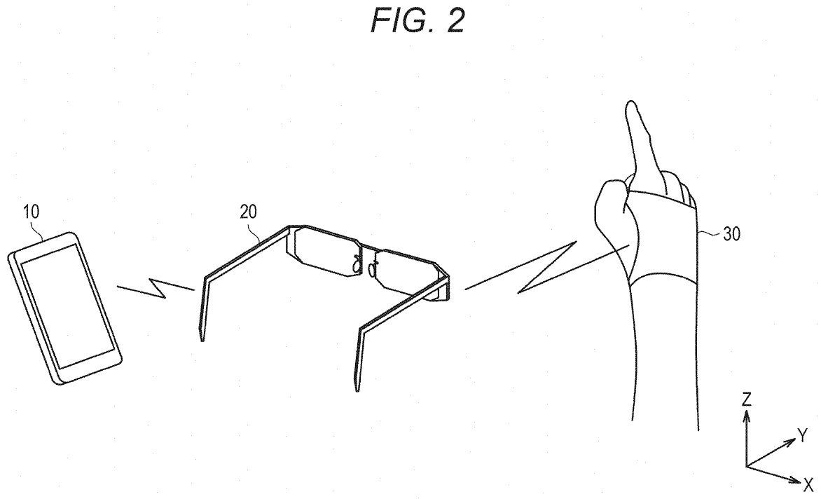

Next, with reference to FIG. 2, an example of a schematic configuration will be described in which a position and an orientation of a palm of the user are acquired by a wearable device 30 worn on the palm (or the back of the hand) by the user, the information processing device 10, and the input/output device 20. FIG. 2 illustrates an example of a case where various contents are presented in response to a motion of a hand of the user, that is, a user's operation input, by applying a so-called augmented reality (AR) technology.

As illustrated in FIG. 2, the information processing system 1 according to the present embodiment includes the information processing device 10, the input/output device 20, and the wearable device 30. The information processing device 10, the input/output device 20, and the wearable device 30 are configured to be able to transmit and receive information to and from each other via a predetermined network. Note that a type of network connecting the information processing device 10, the input/output device 20, and the wearable device 30 is not particularly limited.

The input/output device 20 acquires information for detecting a position and an orientation of the palm-mounted wearable device 30 (as an example, with relatively low accuracy) as input information, and outputs the acquired input information to the information processing device 10. Hereinafter, a case will be mainly assumed in which acceleration information and angular velocity information outputted from an inertial measurement unit (IMU) of the wearable device 30 are used as such input information. However, such input information is not limited to the information outputted from the IMU. For example, such input information may be information outputted from a magnetic sensor as described later.

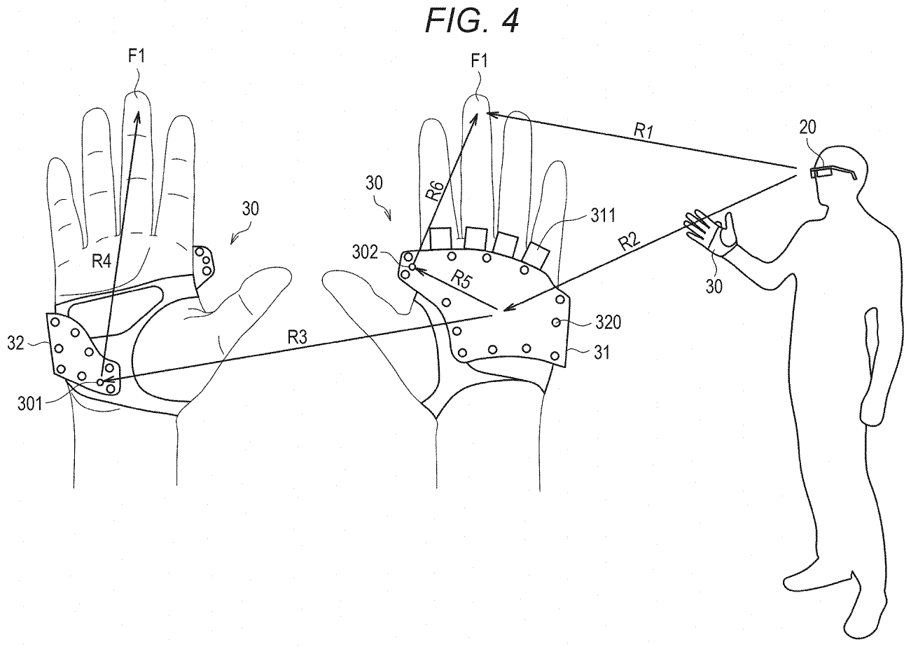

Moreover, the wearable device 30 includes optical markers (for example, active markers of light emitting diode (LED) emission, passive markers of a retroreflective material, or the like) arranged in a prescribed pattern. Note that, since the wearable device 30 illustrated in FIG. 2 is simply illustrated, the optical markers are not illustrated, but the optical markers will be described in detail later with reference to FIG. 4. The input/output device 20 acquires an image obtained by imaging the optical marker. The information processing device 10 acquires a position and an orientation of the wearable device 30 (for example, with relatively high accuracy) on the basis of input information of the captured image of the optical marker acquired by the input/output device 20.

According to these configurations, the position and the orientation of the wearable device 30 can be obtained (for example, with relatively low accuracy) when a distance between the input/output device 20 and the wearable device 30 is within a certain range (for example, 1 m), and the position and the orientation of the wearable device 30 can be obtained (for example, with relatively high accuracy) only in a case where at least a certain number or more of the optical markers of the wearable device 30 are shown in a field of view (FoV) of a recognition camera provided in the input/output device 20.

Note that, in FIGS. 1 and 2, the input/output device 20 and the information processing device 10 are illustrated as different devices, but the input/output device 20 and the information processing device 10 may be integrally configured. Furthermore, details of configurations and processing of the input/output device 20 and the information processing device 10 will be separately described later.

An example of a schematic configuration of the information processing system 1 according to an embodiment of the present disclosure has been described above with reference to FIGS. 1 and 2.

### 2. Configuration of Input/Output Device

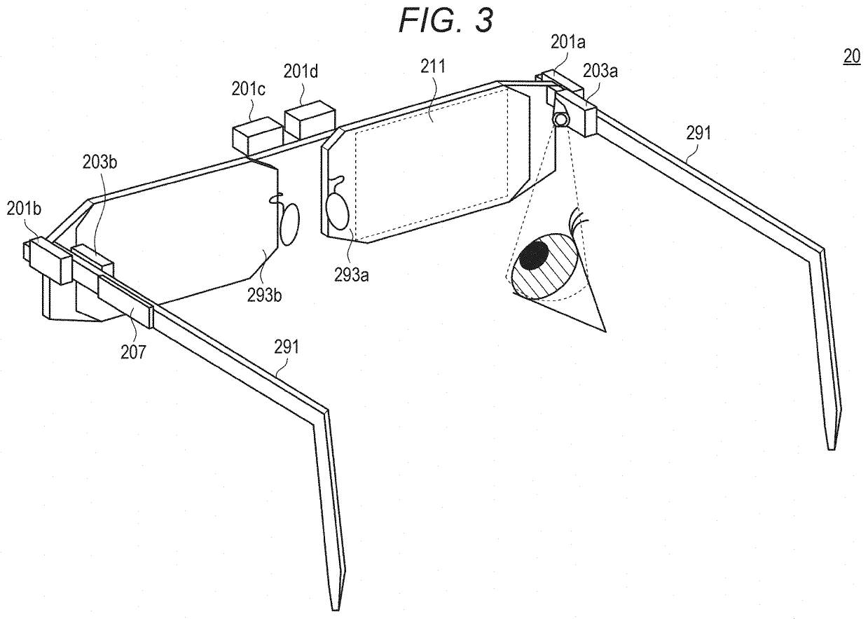

Next, with reference to FIG. 3, an example of a schematic configuration of the input/output device 20 according to the present embodiment illustrated in FIGS. 1 and 2 will be described. FIG. 3 is an explanatory view for explaining an example of a schematic configuration of the input/output device 20 according to the present embodiment.

As described above, the input/output device 20 according to the present embodiment is configured as a so-called head-mounted device that is used by being worn on at least a part of the head by the user, and at least any of lenses 293a and 293b is configured as a transmissive display (a display unit 211). Furthermore, the input/output device 20 includes imaging units 201a and 201b, an operation unit 207, and a holding unit 291 corresponding to a frame of glasses. Furthermore, the input/output device 20 may include imaging units 203a and 203b. Note that, hereinafter, various descriptions will be given on the assumption that the input/output device 20 includes the imaging units 203a and 203b. When the input/output device 20 is worn on the head of the user, the holding unit 291 holds the display unit 211, the imaging units 201a and 201b, the imaging units 203a and 203b, and the operation unit 207 so as to have a predetermined positional relationship with respect to the head of the user. Furthermore, although not illustrated in FIG. 3, the input/output device 20 may include a sound collection unit for collection of user's voice.

Here, a more specific configuration of the input/output device 20 will be described. For example, in the example illustrated in FIG. 3, the lens 293a corresponds to a lens on the right eye side, and the lens 293b corresponds to a lens on the left eye side. That is, in a case where the input/output device 20 is worn, the holding unit 291 holds the display unit 211 such that the display unit 211 (in other words, the lenses 293a and 293b) is positioned in front of the eyes of the user.

The imaging units 201a and 201b are configured as so-called stereo cameras, and are individually held by the holding unit 291 so as to face a direction in which the head of the user faces (that is, in front of the user) when the input/output device 20 is worn on the head of the user. At this time, the imaging unit 201a is held in the vicinity of the right eye of the user, and the imaging unit 201b is held in the vicinity of the left eye of the user. On the basis of such a configuration, the imaging units 201a and 201b image a subject (in other words, a real object located in the real space) located in front of the input/output device 20 from different positions. As a result, the input/output device 20 can acquire an image of the subject located in front of the user, and calculate a distance to the subject from the input/output device 20 (accordingly, a position of a viewpoint of the user) on the basis of parallax between images captured by the imaging units 201a and 201b.

Note that the configuration and method are not particularly limited as long as the distance between the input/output device 20 and the subject can be measured. As a specific example, the distance between the input/output device 20 and the subject may be measured on the basis of a method such as multi-camera stereo, moving parallax, time of flight (TOF), or Structured Light.

Here, the TOF is a method of obtaining an image (a so-called distance image) including a distance (a depth) to a subject on the basis of a measurement result, by projecting light such as infrared rays to a subject and measuring a time until the projected light is reflected by the subject and returned for every pixel.

Furthermore, the Structured Light is a method of obtaining a distance image including a distance (a depth) to a subject on the basis of a change in pattern obtained from an imaging result by irradiating the subject with the pattern with light such as infrared rays and imaging the pattern.

Furthermore, the moving parallax is a method of measuring a distance to a subject on the basis of parallax even in a so-called monocular camera. Specifically, by moving the camera, the subject is imaged from different viewpoints, and a distance to the subject is measured on the basis of parallax between the captured images.

Note that, at this time, by recognizing a moving distance and a moving direction of the camera by various sensors, the distance to the subject can be measured more accurately. Note that a configuration of the imaging unit (for example, a monocular camera, a stereo camera, or the like) may be changed according to the distance measurement method.

Furthermore, the imaging units 203a and 203b are individually held by the holding unit 291 such that eyeballs of the user are positioned within individual imaging ranges when the input/output device 20 is worn on the head of the user. As a specific example, the imaging unit 203a is held such that the right eye of the user is positioned within the imaging range. On the basis of such a configuration, it is possible to recognize a direction in which a line-of-sight of the right eye is directed on the basis of an image of the eyeball of the right eye captured by the imaging unit 203a and a positional relationship between the imaging unit 203a and the right eye. Similarly, the imaging unit 203b is held such that the left eye of the user is positioned within the imaging range. That is, a direction in which a line-of-sight of the left eye is directed can be recognized on the basis of an image of the eyeball of the left eye captured by the imaging unit 203b and a positional relationship between the imaging unit 203b and the left eye. Note that the example illustrated in FIG. 3 illustrates a configuration in which the input/output device 20 includes both the imaging units 203a and 203b, but only any of the imaging units 203a and 203b may be provided.

Furthermore, an infrared (IR) light source 201c and an IR imaging unit 201d for hand position detection are for obtaining a position and an orientation of the wearable device 30 (as viewed from the input/output device 20). Infrared light (for example, 940 nm) emitted from the IR light source 201c is reflected by an optical marker (FIG. 4) of the retroreflective material of the wearable device 30, and is imaged by the IR imaging unit 201d (alternatively, a configuration may be adopted in which the IR light source 201c is not provided, and an optical marker 320 (FIG. 4) is an IR LED (for example, having a wavelength of 940 nm) and emits light by itself). The IR imaging unit 201d includes a bandpass filter through which only infrared light (centered on a 940 nm band as an example) passes, and only a bright spot of the optical marker 320 (FIG. 4) is imaged. A relative position and orientation of the wearable device 30 from the input/output device 20 can be obtained (for example, with relatively high accuracy) from the image of the bright spot.

The operation unit 207 is a configuration to receive an operation on the input/output device 20 from the user. The operation unit 207 may include, for example, an input device such as a touch panel or a button. The operation unit 207 is held at a predetermined position of the input/output device 20 by the holding unit 291. For example, in the example illustrated in FIG. 3, the operation unit 207 is held at a position corresponding to a temple of glasses.

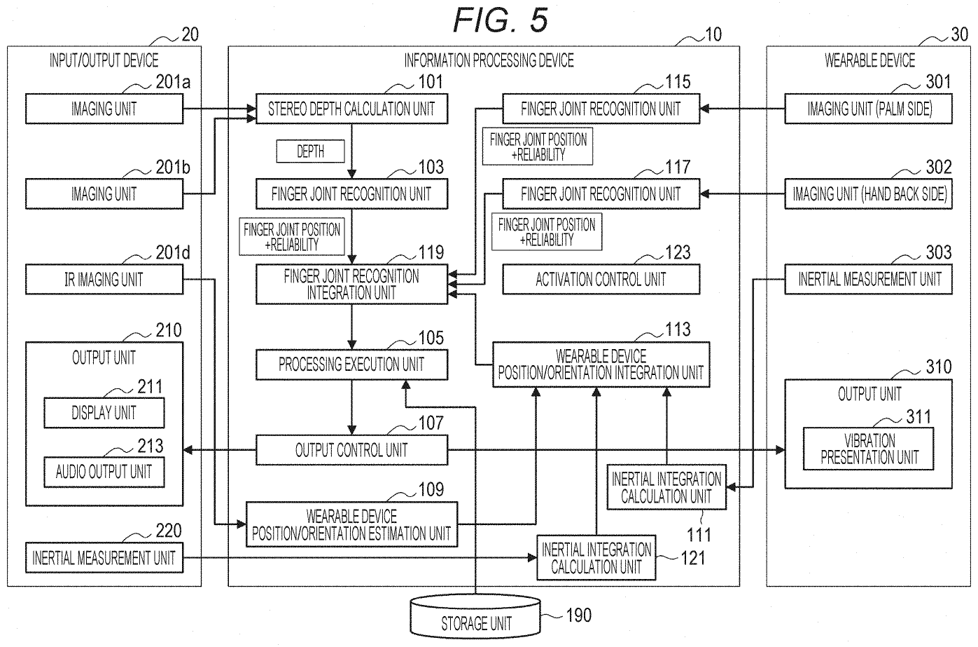

Furthermore, the input/output device 20 according to the present embodiment is provided with, for example, an inertial measurement unit 220 (FIG. 5) (IMU) including an acceleration sensor, a gyro sensor (an angular velocity sensor), and the like (not illustrated). The input/output device 20 can acquire acceleration information and angular velocity information outputted from the IMU. Then, a motion of the head of the user wearing the input/output device 20 (in other words, a motion of the input/output device 20 itself) can be detected on the basis of such acceleration information and angular velocity information. As a specific example, by acquiring the acceleration information and the angular velocity information outputted by the IMU of the input/output device 20, calculating a position and an orientation of the input/output device 20 by inertial navigation, and correcting a drift error generated at that time by a regression model, the information processing device 10 can estimate position information and orientation information of the input/output device 20 and acquire the position and the orientation of the head of the user.

On the basis of the configuration described above, the input/output device 20 according to the present embodiment can recognize a change in position and orientation of the self in the real space according to a motion of the head of the user. Furthermore, at this time, the input/output device 20 can also present a virtual content (that is, a virtual object) on the display unit 211 such that the virtual content is superimposed on a real object located in the real space, on the basis of a so-called AR technology. Furthermore, at this time, on the basis of a technology called simultaneous localization and mapping (SLAM) or the like, for example, the input/output device 20 may estimate the position and the orientation of the self (that is, an own position) in the real space, and use an estimation result for presentation of the virtual object.

Here, an overview of the SLAM will be described as a reference. The SLAM is a technique of performing own position estimation and creation of an environmental map in parallel by using an imaging unit such as a camera, various sensors, an encoder, and the like. As a more specific example, in the SLAM (in particular, Visual SLAM), a three-dimensional shape of a captured scene (or subject) is sequentially restored on the basis of a moving image captured by the imaging unit. Then, by associating a restoration result of the captured scene with a detection result of a position and an orientation of the imaging unit, a map of a surrounding environment is created, and the position and the orientation of the imaging unit (accordingly, the input/output device 20) in the environment are estimated. Note that, for example, by providing various sensors such as an acceleration sensor and an angular velocity sensor in the input/output device 20, the position and the orientation of the imaging unit can be estimated as information indicating a relative change on the basis of a detection result of the sensor. Of course, as long as the position and the orientation of the imaging unit can be estimated, the method is not necessarily limited only to the method based on detection results of various sensors such as the acceleration sensor and the angular velocity sensor.

Furthermore, examples of a head-mounted display device (a head mounted display: HMD) applicable as the input/output device 20 include a see-through HMD, a video see-through HMD, and a retinal projection HMD.

The see-through HMD uses, for example, a half mirror or a transparent light guide plate to hold a virtual image optical system including a transparent light guide unit or the like in front of the user's eyes, and controls to display an image inside the virtual image optical system. Therefore, the user wearing the see-through HMD can view external scenery while viewing the image displayed inside the virtual image optical system. With such a configuration, the see-through HMD can also superimpose an image of the virtual object on an optical image of a real object located in a real space in accordance with a recognition result of at least any of a position or an orientation of the see-through HMD, for example, on the basis of the AR technology. Note that, as a specific example of the see-through HMD, there is a so-called glasses-type wearable device in which a portion corresponding to a lens of glasses is configured as a virtual image optical system. For example, the input/output device 20 illustrated in FIG. 3 corresponds to an example of a see-through HMD.

In a case where the video see-through HMD is worn on the head or the face of the user, the video see-through HMD is worn so as to cover the eyes of the user, and a display unit such as a display is held in front of the eyes of the user. Furthermore, the video see-through HMD includes an imaging unit to capture an image of surrounding scenery, and causes the display unit to display the image of the scenery captured by the imaging unit in front of the user. With such a configuration, although it is difficult for the user wearing the video see-through HMD to directly view the external scenery, it becomes possible to recognize the external scenery with the image displayed on the display unit. Furthermore, at this time, the video see-through HMD may superimpose a virtual object on an image of external scenery in accordance with a recognition result of at least any of a position or an orientation of the video see-through HMD, for example, on the basis of the AR technology.

In the retinal projection HMD, a projection unit is held in front of the eyes of the user, and an image is projected from the projection unit toward the eyes of the user such that the image is superimposed on external scenery. More specifically, in the retinal projection HMD, an image is directly projected from the projection unit onto the retina of the user's eye, and the image is formed on the retina. With such a configuration, even in a case of a near-sighted or far-sighted user, a clearer video image can be visually recognized. Furthermore, the user wearing the retinal projection HMD can view external scenery even while viewing the image projected from the projection unit. According to such a configuration, the retinal projection HMD can also superimpose an image of a virtual object on an optical image of a real object located in a real space in accordance with a recognition result of at least any of a position or an orientation of the retinal projection HMD, for example, on the basis of the AR technology.

Furthermore, in the description described above, an example of the configuration of the input/output device 20 according to the present embodiment has been described on the assumption that the AR technology is applied, but the configuration of the input/output device 20 is not necessarily limited. For example, in a case where it is assumed that a VR technology is applied, the input/output device 20 according to the present embodiment may be configured as an HMD called an immersive HMD. Similarly to the video see-through HMD, the immersive HMD is worn so as to cover the eyes of the user, and a display unit such as a display is held in front of the eyes of the user. Therefore, it is difficult for the user wearing the immersive HMD to directly view external scenery (that is, scenery in the real world), and only a video image displayed on the display unit comes into the sight. With such a configuration, the immersive HMD can give a sense of immersion to the user viewing the image.

An example of the schematic configuration of the input/output device 20 according to the embodiment of the present disclosure has been described above with reference to FIG. 3.

### 3. Configuration of Wearable Device

Next, with reference to FIG. 4, an example of a schematic configuration of the wearable device 30 according to the present embodiment illustrated in FIGS. 1 and 2 will be described. FIG. 4 is an explanatory view for explaining an example of a schematic configuration of the wearable device 30 according to the present embodiment.

As described above, the wearable device 30 according to the present embodiment is configured as a so-called mounted device that is used by being worn on a palm of a user. For example, in the example illustrated in FIG. 4, the wearable device 30 is configured as a so-called palm vest device. Furthermore, the wearable device 30 includes an imaging unit (palm side) 301 and an imaging unit (hand back side) 302, the imaging unit (palm side) 301 is arranged on the palm side so that a finger of the hand on which the wearable device 30 is worn can be imaged from the palm side, and the imaging unit (hand back side) 302 is arranged on the hand back side so that a finger of the hand on which the wearable device 30 is worn can be imaged from the hand back side.

Note that each of the imaging unit (palm side) 301 and the imaging unit (hand back side) 302 is configured as a TOF sensor, and can obtain a depth (a distance to a finger) on the basis of a depth image obtained by the TOF sensor. However, a type of the sensor of each of the imaging unit (palm side) 301 and the imaging unit (hand back side) 302 is not limited to the TOF sensor, and may be another sensor capable of obtaining the depth. Alternatively, one or both of the imaging unit (palm side) 301 and the imaging unit (hand back side) 302 may be a 2D sensor such as an IR sensor.

Furthermore, the wearable device 30 includes a plurality of optical markers 320 whose surfaces are retroreflective materials, an inertial measurement unit 303 (FIG. 5), and a vibration presentation unit 311. Referring to FIG. 4, a finger F1 is illustrated. Furthermore, a relative position and orientation of the finger F1 (as viewed from the imaging unit 201) are illustrated as a position/orientation R1. Here, the relative position (as viewed from the imaging unit 201) can be represented by coordinates in a camera coordinate system with respect to the imaging unit 201. Note that the imaging unit 201 as a reference is not particularly limited (for example, the imaging unit 201a may be the reference).

Furthermore, a relative position and orientation of the wearable device 30 (as viewed from the imaging unit 201) are illustrated as a position/orientation R2. Moreover, a relative position and orientation (as viewed from the wearable device 30) of the imaging unit (palm side) 301 are illustrated as a position/orientation R3. Furthermore, a relative position and orientation of the finger F1 (as viewed from the imaging unit (palm side) 301) are illustrated as a position/orientation R4. Moreover, a relative position and orientation (as viewed from the wearable device 30) of the imaging unit (hand back side) 302 are illustrated as a position/orientation R5. Furthermore, a relative position and orientation of the finger F1 (as viewed from the imaging unit (hand back side) 302) are illustrated as a position/orientation R6.

Note that, in FIG. 4, the finger F1 corresponding to the middle finger is illustrated as an example of the finger. However, as will be described later, in the present embodiment, a finger (that is, the thumb, the index finger, the ring finger, and the little finger) other than the middle finger can be treated as a finger similarly to the finger F1 corresponding to the middle finger.

The optical marker 320 reflects irradiation light of the IR light source 201c of the input/output device 20. The reflected light is imaged by the IR imaging unit 201d, and a relative position and orientation (as viewed from the imaging unit 201) of the wearable device 30 are obtained (as an example, with relatively high accuracy) from a bright spot of the obtained video image. Note that the optical marker 320 is not limited to a passive marker using a retroreflective material, and may be an active marker using an IR LED. In a case where the optical marker 320 is an active marker, the IR light source 201c of the input/output device 20 is unnecessary.

The inertial measurement unit 303 (FIG. 5) includes, for example, an IMU, and can acquire acceleration information and angular velocity information outputted from the IMU, similarly to the IMU included in the input/output device 20. On the basis of such acceleration information and angular velocity information, a motion of the hand of the user wearing the wearable device 30 (in other words, a motion of the wearable device 30 itself) can be detected. As a specific example, by acquiring the acceleration information and the angular velocity information outputted by the IMU sensor of the wearable device 30, calculating a position and an orientation of the wearable device 30 by inertial navigation, and correcting a drift error generated at that time by a regression model, the information processing device 10 can estimate position information and orientation information of the wearable device 30 and acquire the position and the orientation of the hand of the user.

The vibration presentation unit 311 presents tactile sensation to the user's hand by driving a vibration actuator that generates vibration.

Specifically, while a translation actuator such as a voice coil motor or a linear resonant actuator (LRA), or a rotation actuator such as an eccentric motor is used as the vibration actuator, using the translation actuator makes it possible to drive in a wide frequency range, and high expressiveness of vibration can be obtained. In a case of using the translation actuator, the vibration actuator is driven by applying a voltage of a time-varying analog waveform close to an audio signal. It is conceivable that the vibration actuators are installed at a plurality of places according to a vibration intensity desired to be presented and a part to be presented. Furthermore, apart from a method of directly arranging the vibration actuator on a part (such as a palm) to which vibration is to be presented, for example, a method is also conceivable in which the vibration actuator is arranged on a palm and tactile sensation is presented in a palm shape, in consideration of vibration propagation characteristics for every frequency and a difference in sensitivity of the tactile sensation of the hand.

### 4. Functional Configuration of System

Next, with reference to FIG. 5, an example of a functional configuration of the information processing system 1 according to the present embodiment will be described. FIG. 5 is a block diagram illustrating an example of a functional configuration of the information processing system 1 according to the present embodiment.

Hereinafter, as described with reference to FIG. 1, configurations of the information processing device 10, the input/output device 20, and the wearable device 30 will be described in more detail on the assumption that the information processing system 1 includes the information processing device 10, the input/output device 20, and the wearable device 30. Note that, as illustrated in FIG. 5, the information processing system 1 may include a storage unit 190.

First, a configuration of the input/output device 20 will be described. As illustrated in FIG. 5, the input/output device 20 includes the imaging units 201a, 201b, and 201d, an output unit 210, and the inertial measurement unit 220 (IMU). The output unit 210 includes the display unit 211. Furthermore, the output unit 210 may include an audio output unit 213. The imaging units 201a, 201b, and 201d correspond to the imaging units 201a, 201b, and 201d described with reference to FIG. 2.

Note that, in a case where it is not necessary to particularly distinguish from each other, the imaging units 201a, 201b, and 201d may be simply referred to as an “imaging unit 201”. Furthermore, the display unit 211 corresponds to the display unit 211 described with reference to FIG. 2. Furthermore, the audio output unit 213 includes an audio device such as a speaker, and outputs voice or audio according to information to be an output target. Furthermore, although not illustrated in FIG. 5, as described above, the input/output device 20 also includes the operation unit 207, the imaging units 203a and 203b, the holding unit 291, and the like.

Next, a configuration of the wearable device 30 will be described. As illustrated in FIG. 5, the wearable device 30 includes the imaging unit (palm side) 301, the imaging unit (hand back side) 302, the inertial measurement unit 303 (IMU), and an output unit 310. The output unit 310 includes the vibration presentation unit 311. The vibration presentation unit 311 includes the vibration actuator, and presents vibration according to information to be an output target. Furthermore, although not illustrated in FIG. 5, as described above, the wearable device 30 also includes the optical marker 320 and the like.

Next, a configuration of the information processing device 10 will be described. As illustrated in FIG. 5, the information processing device 10 includes a stereo depth calculation unit 101, a finger joint recognition unit 103, a finger joint recognition unit 115, a finger joint recognition unit 117, and a finger joint recognition integration unit 119. Furthermore, the information processing device 10 includes a wearable device position/orientation estimation unit 109, an inertial integration calculation unit 111, an inertial integration calculation unit 121, and a wearable device position/orientation integration unit 113. Furthermore, the information processing device 10 includes a processing execution unit 105 and an output control unit 107. Moreover, the information processing device 10 includes an activation control unit 123. The activation control unit 123 will be described in detail later.

The stereo depth calculation unit 101 acquires images (imaging results) individually outputted from the imaging units 201a and 201b, and generates depth images of a field of view of the imaging units 201a and 201b on the basis of the acquired images. Then, the stereo depth calculation unit 101 outputs the depth images of the field of view of the imaging units 201a and 201b to the finger joint recognition unit 103.

The finger joint recognition unit 103 acquires the depth image generated by the stereo depth calculation unit 101 from the stereo depth calculation unit 101, and recognizes a position of each of the plurality of finger joints on the basis of the acquired depth image. Details of the recognition of each of the finger joint positions will be described later. Then, the finger joint recognition unit 103 outputs a relative position (as viewed from the imaging unit 201) of each recognized finger joint position to the finger joint recognition integration unit 119 as a position/orientation, and outputs reliability (described later) of the recognition result of each finger joint position to the finger joint recognition integration unit 119. Furthermore, in a case where there is a finger joint whose recognition (or estimation) of the position has failed from the depth image, the finger joint recognition unit 103 outputs a result indicating impossibility of estimation as a finger joint (a recognition result) whose recognition has failed.

The finger joint recognition unit 115 acquires an image (an imaging result) outputted from the imaging unit (palm side) 301, and recognizes each finger joint position on the basis of the acquired image. Then, the finger joint recognition unit 115 outputs the recognized relative position of each finger joint (as viewed from the imaging unit (palm side) 301) to the finger joint recognition integration unit 119 as the position/orientation R4 (FIG. 4), and outputs reliability (described later) of the recognition result of each finger joint position to the finger joint recognition integration unit 119.

Similarly, the finger joint recognition unit 117 acquires an image (an imaging result) outputted from the imaging unit (hand back side) 302, and recognizes each finger joint position on the basis of the acquired image. Then, the finger joint recognition unit 117 outputs the recognized relative position of each finger joint (as viewed from the imaging unit (hand back side) 302) to the finger joint recognition integration unit 119 as the position/orientation R6 (FIG. 4), and outputs reliability (described later) of the recognition result of each finger joint position to the finger joint recognition integration unit 119.

Here, the relative position of each finger joint (as viewed from the wearable device 30) is represented by coordinates in a coordinate system with respect to the wearable device 30. Note that the coordinate system with respect to the wearable device 30 is not particularly limited (for example, the coordinate system with respect to the wearable device 30 may be a camera coordinate system of the imaging unit 301). Furthermore, in a case where there is a finger joint whose recognition (or estimation) of the position has failed from the image, each of the finger joint recognition unit 115 and the finger joint recognition unit 117 outputs a result indicating impossibility of estimation as a finger joint (a recognition result) whose recognition has failed.

The wearable device position/orientation estimation unit 109 acquires an image (an imaging result) outputted from the IR imaging unit 201d. In such an image, a plurality of bright spots, which is reflected light of the optical marker 320 included in the wearable device 30, is shown. Therefore, the wearable device position/orientation estimation unit 109 can estimate the relative position and orientation (as viewed from the imaging unit 201) of the wearable device 30 as a position/orientation on the basis of a positional relationship among the plurality of bright spots. The wearable device position/orientation estimation unit 109 outputs the recognized relative position/orientation (hereinafter, also referred to as a “position/orientation P1”) of the wearable device 30 (as viewed from the imaging unit 201), to the wearable device position/orientation integration unit 113.

Here, the relative position/orientation P1 (as viewed from the imaging unit 201) of the wearable device 30 recognized by the wearable device position/orientation estimation unit 109 is expressed by the camera coordinate system with respect to the imaging unit 201. As described above, the reference imaging unit 201 is not particularly limited.

Note that a field of view of the IR imaging unit 201d does not necessarily include all the optical markers 320 of the wearable device 30 (that is, the field of view of the IR imaging unit 201d may not include the optical marker 320 at all or may include only some of the optical markers 320). Alternatively, even when all the optical markers 320 of the wearable device 30 are included in the field of view of the IR imaging unit 201d, the entire reflected light of the optical marker 320 is not necessarily captured by the IR imaging unit 201d due to occlusion or the like (that is, the IR imaging unit 201d may not capture reflected light of the optical marker 320 at all or may capture only some of the optical markers 320). In a case where only less than a certain number of (for example, five) markers among all the optical markers 320 are imaged, the wearable device position/orientation estimation unit 109 outputs a result indicating impossibility of estimation.

The inertial integration calculation unit 111 acquires acceleration information and angular velocity information from the inertial measurement unit 303 (IMU) of the wearable device 30, and estimates a position and an orientation (hereinafter, also referred to as a “position/orientation P2”) of the wearable device 30 (for example, with relatively low accuracy) on the basis of the acquired acceleration information and angular velocity information. Such a position/orientation P2 is expressed by a global coordinate system. For example, by calculating a position and an orientation of the wearable device 30 by inertial navigation, and correcting a drift error generated at that time by using a regression model, the inertial integration calculation unit 111 can estimate position information and orientation information of the wearable device 30. The inertial integration calculation unit 111 outputs the position/orientation P2 of the wearable device 30 expressed in the global coordinate system, to the wearable device position/orientation integration unit 113.

Similarly, the inertial integration calculation unit 121 acquires acceleration information and angular velocity information from the inertial measurement unit 220 (IMU) of the input/output device 20, and estimates a position and an orientation (hereinafter, also referred to as a “position/orientation P3”) of the input/output device 20 on the basis of the acquired acceleration information and angular velocity information. Such a position/orientation P3 is expressed by a global coordinate system. For example, by calculating a position and an orientation of the input/output device 20 by inertial navigation, and correcting a drift error generated at that time by using a regression model, the inertial integration calculation unit 121 can estimate position information and orientation information of the input/output device 20. The inertial integration calculation unit 121 outputs the position/orientation P3 of the input/output device 20 expressed in the global coordinate system, to the wearable device position/orientation integration unit 113.

The wearable device position/orientation integration unit 113 acquires the relative position/orientation P1 (viewed from the imaging unit 201) of the wearable device 30 outputted by the wearable device position/orientation estimation unit 109. Such a position/orientation P1 is expressed by the camera coordinate system with respect to the imaging unit 201 (for example, the imaging unit 201a). Moreover, the wearable device position/orientation integration unit 113 acquires the position/orientation P2 of the inertial measurement unit 303 of the wearable device 30 outputted by the inertial integration calculation unit 111, and the position/orientation P3 of the inertial measurement unit 220 of the input/output device 20 outputted by the inertial integration calculation unit 121. Such positions/orientations P2 and P3 are individually expressed by a global coordinate system.

The wearable device position/orientation integration unit 113 calculates a relative position/orientation of the position/orientation P2 of the wearable device 30 viewed from the position/orientation P3 of the input/output device 20, and calculates a position/orientation (hereinafter, also referred to as a “position/orientation P4”) of the wearable device 30 expressed by a coordinate system (for example, the camera coordinate system of the imaging unit 201a) with respect to the imaging unit 201, by using a positional relationship between the IMU and the camera obtained by IMU-camera calibration or the like in advance. The wearable device position/orientation integration unit 113 integrates the position/orientation P1 and the position/orientation P4, and outputs the integrated position/orientation R2 (FIG. 4) to the finger joint recognition integration unit 119. The integrated position/orientation R2 is expressed by a coordinate system (for example, the camera coordinate system of the imaging unit 201a) with respect to the imaging unit 201.

Here, the integration of position/orientation may be performed in any manner. For example, if the position/orientation P1 estimated by the wearable device position/orientation estimation unit 109 is available (except for a case of indicating impossibility of estimation), the wearable device position/orientation integration unit 113 outputs the position/orientation P1 to the finger joint recognition integration unit 119. Whereas, the wearable device position/orientation integration unit 113 outputs the position/orientation P4 to the finger joint recognition integration unit 119 in a case where impossibility of estimation is outputted from the wearable device position/orientation estimation unit 109.

Note that, here, a case has been mainly assumed in which the wearable device position/orientation integration unit 113 integrates a position/orientation of the wearable device 30 based on an imaging result of an optical marker obtained by the IR imaging unit 201d of the input/output device 20, and a position/orientation of the wearable device 30 based on information outputted from the IMU (of each of the input/output device 20 and the wearable device 30). However, the position/orientation of the wearable device 30 outputted from the wearable device position/orientation integration unit 113 to the finger joint recognition integration unit 119 is not limited to such an example.

For example, among: a position/orientation of the wearable device 30 based on an imaging result of an optical marker; a position/orientation of the wearable device 30 based on information outputted from the IMU; a position/orientation of the wearable device 30 based on magnetic tracking; and a position/orientation of the wearable device 30 based on ultrasonic sensing, the wearable device position/orientation integration unit 113 may output any one or an integration result of at least any two to the finger joint recognition integration unit 119.

By using the position/orientation R2 (FIG. 4) of the wearable device 30 outputted by the wearable device position/orientation integration unit 113, the finger joint recognition integration unit 119 expresses again finger joint positions outputted by the finger joint recognition unit 115 and the finger joint recognition unit 117 (FIG. 4 illustrates the position/orientation R4 and the position/orientation R6 as examples of the individual finger joint positions) by a coordinate system (for example, the camera coordinate system of the imaging unit 201a) with respect to the imaging unit 201.

Describing with the example illustrated in FIG. 4, by adding the position/orientation R2, the relative position/orientation R3 (as viewed from the wearable device 30) of the imaging unit (palm side) 301, and each finger joint position (the position/orientation R4) outputted by the finger joint recognition unit 115, the finger joint recognition integration unit 119 can express again each finger joint position (the position/orientation R4) by the coordinate system with respect to the imaging unit 201.

Note that, as illustrated in FIG. 4, the imaging unit (palm side) 301 is provided in a controller unit 31, and the position/orientation R3 does not change according to a worn state of the wearable device 30 by the user (since the controller unit 31 is not deformed). Therefore, the position/orientation R3 can be set in advance before the user wears the wearable device 30.

Similarly, by adding the position/orientation R2, the relative position/orientation R5 (as viewed from the wearable device 30) of the imaging unit (hand back side) 302, and each finger joint position (the position/orientation R6) outputted by the finger joint recognition unit 117, the finger joint recognition integration unit 119 can express again each finger joint position (the position/orientation R6) by the coordinate system with respect to the imaging unit 201. Note that, as illustrated in FIG. 4, in a case where the imaging unit (hand back side) 302 is provided in the controller unit 31, the position/orientation R5 does not change according to a worn state of the wearable device 30 by the user (since the controller unit 31 is not deformed). Therefore, the position/orientation R5 can be set in advance before the user wears the wearable device 30.

Here, the present disclosure is not limited to the example in which the imaging unit (palm side) 301 or the imaging unit (hand back side) 302 is fixed to the wearable device 30. For example, a band part 32 or the like may be deformed according to a worn state of the wearable device 30 by the user, and the position/orientation R3 or R5 may be changed. In that case, each own position may be estimated using the SLAM for the imaging unit (palm side) 301 and the imaging unit (hand back side) 302, and the position/orientation R3 or R5 may be calculated in real time. Then, the finger joint recognition integration unit 119 integrates each finger joint position outputted by the finger joint recognition unit 115 and the finger joint recognition unit 117 and each finger joint position outputted by the finger joint recognition unit 103, which are expressed again by a coordinate system with respect to the imaging unit 201 (for example, the camera coordinate system of the imaging unit 201a), by using reliability (described later) of those. The finger joint recognition integration unit 119 outputs each integrated finger joint position to the processing execution unit 105 as a final estimation result of the finger joint position (as a recognition result of the user input).

The processing execution unit 105 is a configuration to execute various functions (for example, an application) provided by the information processing device 10 (accordingly, the information processing system 1). For example, in accordance with each finger joint position (a recognition result of the user input) outputted from the finger joint recognition integration unit 119, the processing execution unit 105 may extract a corresponding application from a predetermined storage unit (for example, the storage unit 190 to be described later), and execute the extracted application.

Alternatively, the processing execution unit 105 may control an operation of the application being executed, in accordance with each finger joint position outputted from the finger joint recognition integration unit 119. For example, the processing execution unit 105 may switch subsequent operations of the application being executed, in accordance with each finger joint position.

Alternatively, the processing execution unit 105 may output information indicating execution results of various applications to the output control unit 107.

The output control unit 107 presents information to the user by outputting various types of information to be an output target, to the output unit 210 and the output unit 310. For example, the output control unit 107 may present display information to the user by causing the display unit 211 to display the display information to be an output target. As an example, on the basis of each finger joint position (that is, a recognition result of a finger) outputted from the finger joint recognition integration unit 119, the output control unit 107 may control the display unit 211 to display a virtual object operable by the user. Alternatively, the output control unit 107 may present information to the user by causing the audio output unit 213 to output audio corresponding to information to be an output target. Alternatively, the output control unit 107 may present information to the user by causing the vibration presentation unit 311 to output vibration according to information to be an output target.

For example, the output control unit 107 may acquire information indicating execution results of various applications from the processing execution unit 105, and present output information according to the acquired information to the user via the output unit 210. Furthermore, the output control unit 107 may cause the display unit 211 to display display information indicating an execution result of a desired application. Furthermore, the output control unit 107 may cause the audio output unit 213 to output output information according to an execution result of a desired application as audio (including voice). Furthermore, the output control unit 107 may cause the vibration presentation unit 311 to output output information according to an execution result of a desired application as vibration.

The storage unit 190 is a storage area (a recording medium) for temporarily or permanently storing various data (the various data may include a program for causing a computer to function as the information processing device 10). For example, the storage unit 190 may store data for the information processing device 10 to execute various functions. As a more specific example, the storage unit 190 may store data (for example, a library) for executing various applications, management data for managing various settings, and the like.

Note that the functional configuration of the information processing system 1 illustrated in FIG. 5 is merely an example, and the functional configuration of the information processing system 1 is not necessarily limited to the example illustrated in FIG. 5 as long as the processing of each configuration described above can be realized. As a specific example, the input/output device 20 and the information processing device 10 may be integrally configured. Furthermore, as another example, the storage unit 190 may be included in the information processing device 10, and may be configured as a recording medium (for example, a recording medium externally attached to the information processing device 10) external to the information processing device 10. Furthermore, as another example, some of the individual configurations of the information processing device 10 may be provided externally to the information processing device 10 (for example, a server or the like).

An example of the functional configuration of the information processing system 1 according to the present embodiment has been described above with reference to FIG. 5.

### 5. Reliability of Finger Joint Recognition

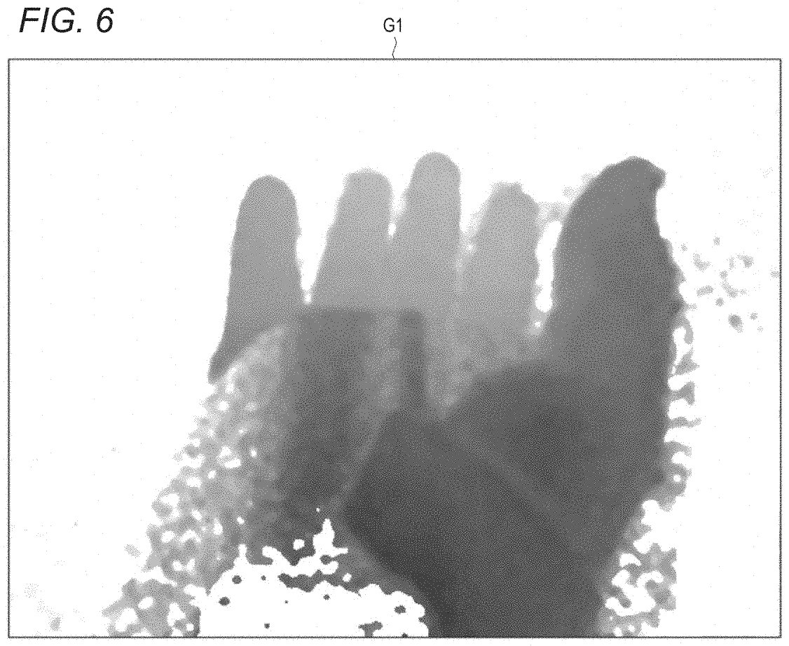

Next, with reference to FIGS. 6 to 9, an example of a reliability calculation method according to an embodiment of the present disclosure will be described.

Note that, as described above, the reliability is information indicating a possibility of being reliable of each finger joint position recognized by each of the finger joint recognition unit 103, the finger joint recognition unit 115, and the finger joint recognition unit 117 on the basis of a depth image, and the reliability is calculated as a value corresponding to each finger recognition position. The calculation method of the reliability may be similar (or different) among the finger joint recognition unit 103, the finger joint recognition unit 115, and the finger joint recognition unit 117.

FIG. 6 is a view illustrating an example of a depth image. Referring to FIG. 6, a depth image G1 is illustrated as an example. The depth image G1 shows a hand of the user wearing the wearable device 30. In the depth image G1, a position where color blackness is stronger indicates a position where a depth is lower (that is, closer to the camera). Conversely, a position where color whiteness is stronger indicates a position where a depth is higher (that is farther from the camera).

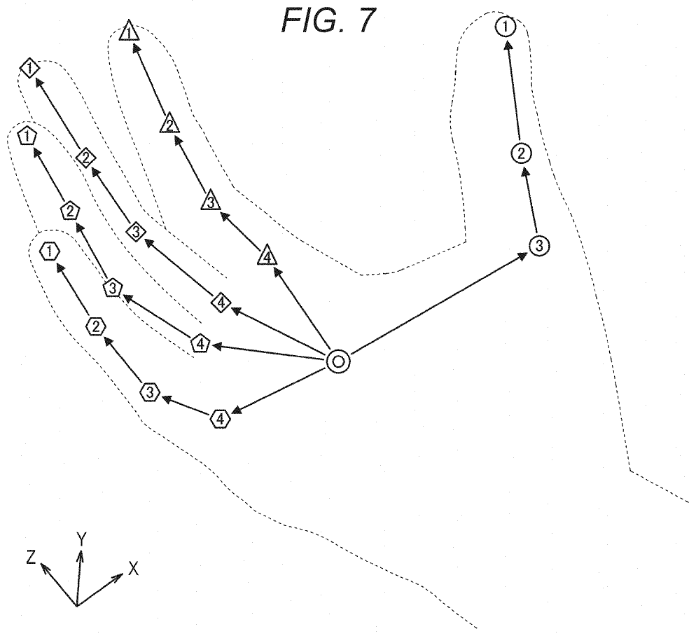

FIG. 7 is a view illustrating an example of a finger joint position. Referring to FIG. 7, an example of each finger joint position recognized on the basis of a depth image (for example, as in the depth image G1 illustrated in FIG. 6) is three-dimensionally illustrated. In the example illustrated in FIG. 7, a center position of the palm is indicated by a double circle, each joint position of the thumb is indicated by a circle, each joint position of the index finger is indicated by a triangle, each joint position of the middle finger is indicated by a rhombus, each joint position of the ring finger is indicated by a pentagon, and each joint position of the little finger is indicated by a hexagon. In the numbers in the individual shapes, “1” indicates a fingertip, “2” indicates a center of the first joint, “3” indicates a center of the second joint, and “4” indicates a center of the third joint (excluding the thumb). Coordinates of each finger joint position are represented by the camera coordinate system.

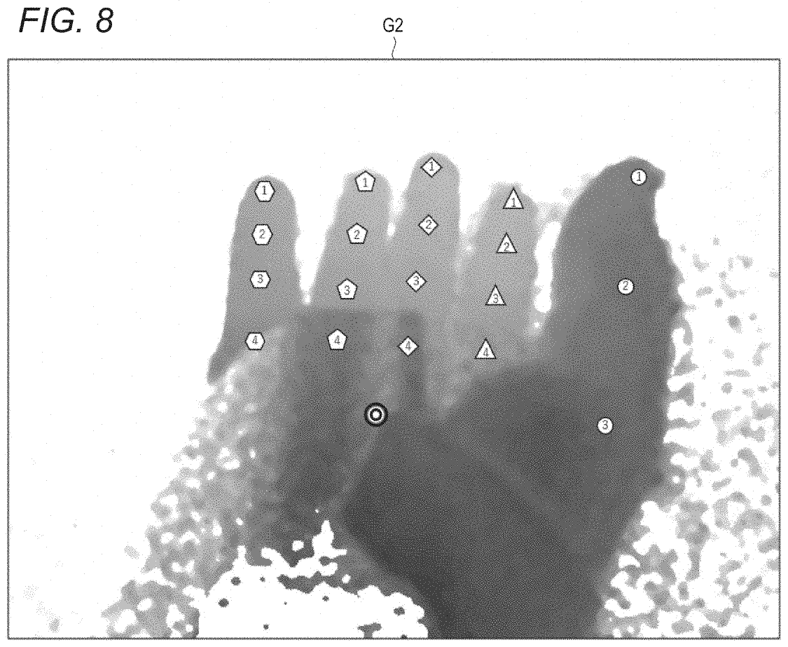

FIG. 8 is a view illustrating an example of an image in which each recognized finger joint position is reprojected on a depth image. Referring to FIG. 8, a reprojection image G2 obtained by reprojecting each recognized finger joint position (for example, as in each joint position illustrated in FIG. 7) onto a depth image (for example, as in the depth image G1 illustrated in FIG. 6) is illustrated. Note that since the camera has obtained an internal parameter and a distortion coefficient by performing camera calibration in advance, conversion from the camera coordinate system to the image coordinate system can be performed using these.

In the camera coordinate system, a front side of the camera (a depth direction of the camera) is defined a z-direction. Here, a pixel value at a position where each recognized finger joint position is reprojected on the depth image represents a distance from the camera, and the distance is defined as V(k). Whereas, a coordinate of each recognized finger joint position is defined as Z(k). At this time, Δ(k)=|V(k)−Z(k)|, which is an absolute value of the difference, is defined as an error in the depth direction of the finger joint position. Note that Δ(k) may correspond to an example of an error in the depth direction for every finger joint position.

Then, a root mean square (RMS) of the error in the depth direction of the all finger joints positions can be calculated as D by the following Equation (1). Note that, in Equation (1), n represents the number of finger joints.

$$\begin{matrix}[ Formula 1 ] & \\ D = \sqrt{( \frac{1}{n} ) \sum {( Δ ( k ) )}^{2}} & ( 1 )\end{matrix}$$

Then, the reliability of the finger joint can be calculated as 1/(1+D) by using D calculated as in Equation (1). That is, the reliability takes a maximum value 1 when D is 0, and the reliability approaches 0 when the error in the depth direction of each joint increases. Note that 1/(1+D) is merely an example of the reliability of the finger joint position. Therefore, the method of calculating the reliability of the finger joint position is not limited to such an example. For example, the reliability of the finger joint position may simply be calculated so as to decrease as the error in the depth direction of the finger joint position increases.

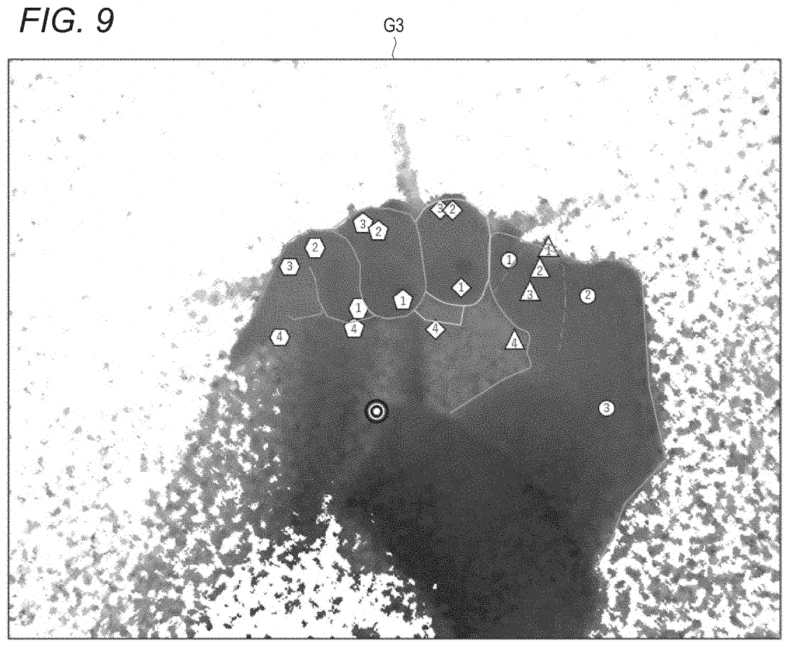

FIG. 9 is a view illustrating another example of an image in which each recognized finger joint position is reprojected on a depth image. Referring to FIG. 9, similarly to the example illustrated in FIG. 8, a reprojection image G3 obtained by reprojecting each recognized finger joint position to a depth image is illustrated. In the reprojection image G3, the index finger is extended and other fingers are bent like clasping. The index finger (the finger having a broken line as a contour line illustrated in FIG. 9) is almost hidden by the thumb and hardly shown in the depth image. Therefore, each joint position of the index finger is recognized to be on a back side of the thumb.

Whereas, the z-coordinate of the position where each joint position of the recognized index finger is reprojected on the depth image is to be a distance from the camera to the surface of the thumb. Therefore, the z-coordinate is to be a shorter value than a distance from the camera to each joint position of the recognized index finger (a distance from the camera to the index finger on the far side of the thumb). Therefore, a difference becomes large between the z-coordinate of each joint position of the recognized index finger and the z-coordinate (a pixel value) of the position where each joint position of the recognized index finger is reprojected on the depth image, and the reliability becomes small.

An example of the reliability calculation method according to the embodiment of the present disclosure has been described above with reference to FIGS. 6 to 9.

### 6. Notable Features

Next, notable features of an embodiment of the present disclosure will be described. As described above, in the information processing device 10 according to an embodiment of the present disclosure, a motion (for example, a change in position or orientation, a gesture, or the like) of a position/orientation of a finger (each finger joint position) of the user is recognized as a user's operation input, and various processes are executed in accordance with a recognition result of the user's operation input. At this time, a method for recognizing the position/orientation of the finger includes a method using an image obtained by the imaging unit of the input/output device 20 mounted on the head of the user, and a method of using an image obtained by the imaging unit of the wearable device 30 mounted on the palm of the user.

In the method of using an image obtained by the imaging unit of the input/output device 20 mounted on the head, while it is easy to secure a battery capacity for driving a sensor, there is a circumstance that some or all of the finger joints may not be shown in the image obtained by the imaging unit of the input/output device 20, due to a phenomenon (so-called self-occlusion) in which some or all of the finger joints are shielded by the user's own body depending on an orientation of the arm or the finger. Moreover, the imaging unit of the input/output device 20 worn on the head of the user is often arranged such that a field of view matches the sight of the user. Therefore, there is a circumstance that some or all of the finger joints may not be shown in the image obtained by the imaging unit of the input/output device 20 in a case where the finger is outside the field of view (for example, on a back side of the head, and the like), for example.

Whereas, in the method of using an image obtained by the imaging unit of the wearable device 30 mounted on the palm, a position/orientation of the user's finger can be acquired without being affected by self-occlusion since the field of view restriction of the imaging unit is small. However, the wearable device 30 to be worn on the palm needs to be downsized in order to be worn on the palm, so that it is difficult to mount a large-capacity battery or the like. Therefore, there is a circumstance that it is difficult to continuously execute capturing of an image (or recognition of a finger based on an image) by the imaging unit for a long time.

Therefore, in the embodiment of the present disclosure, the activation control unit 123 of the information processing device 10 controls switching of an operation unit to be activated between a first operation unit and a second operation unit related to recognition of a finger, on the basis of a detection result of the wearable device 30. According to such a configuration, it is possible to robustly recognize a finger while reducing power consumption required for recognizing the finger. Furthermore, the activation control unit 123 also controls activation of a third operation unit related to recognition of a finger. Note that, hereinafter, controlling the operation unit to be activated may be referred to as “turning ON”, and controlling the operation unit to be stopped may be referred to as “turning OFF”.

Hereinafter, a case will be mainly assumed in which the first operation unit includes at least both of: a first sensor configured to obtain first data (a depth image) in which a finger is recognized; and a first recognition unit configured to recognize the finger on the basis of the first data. However, the first operation unit may include at least any one of such a first sensor or a first recognition unit. Note that, in the following description, a case is mainly assumed in which the imaging units 201a and 201b are used as an example of the first sensor. However, as described above, a sensor instead of the imaging units 201a and 201b may be used as the first sensor. Moreover, in the following description, the finger joint recognition unit 103 is used as an example of the first recognition unit.

Similarly, in the following description, a case is mainly assumed in which the second operation unit includes at least both of: a second sensor configured to obtain second data (a depth image) in which a finger is recognized; and a second recognition unit configured to recognize the finger on the basis of the second data. However, the second operation unit may include at least any one of such a second sensor or a second recognition unit. Note that, in the following description, a case is mainly assumed in which the imaging unit (palm side) 301 is used as an example of the second sensor. However, a sensor instead of the imaging unit (palm side) 301 may be used as the second sensor. Moreover, in the following description, the finger joint recognition unit 115 is used as an example of the second recognition unit.

Moreover, in the following description, a case is mainly assumed in which the third operation unit includes at least both of: a third sensor configured to obtain third data (a depth image) in which a finger is recognized; and a third recognition unit configured to recognize the finger on the basis of the third data. However, the third operation unit may include at least any one of such a third sensor or a third recognition unit. Note that, in the following description, a case is mainly assumed in which the imaging unit (hand back side) 302 is used as an example of the third sensor. However, a sensor instead of the imaging unit (hand back side) 302 may be used as the third sensor. Moreover, in the following description, the finger joint recognition unit 117 is used as an example of the third recognition unit.

Hereinafter, as a recognition target existing in the real space, a user's finger will be described as an example. Moreover, the wearable device 30 (in particular, the optical marker 320) worn on a hand will be described as an example of a detection target. However, the recognition target may not be a finger, and the detection target may not be the wearable device 30. For example, the recognition target may be a body part (for example, a user's arm or palm, or the like) other than a finger. Then, it is sufficient that a position of the detection target changes with a change in position of the recognition target. The recognition target and the detection target are not limited to a case of being different, and may be the same (for example, both the recognition target and the detection target may be a finger).

The imaging unit 301 (as an example of the second sensor) is desirably attached to a position closer to the recognition target than the imaging units 201a and 201b (as examples of the first sensor) on the user's body. In such a case, it is assumed that self-occlusion is less likely to occur in the imaging unit 301 than in the imaging units 201a and 201b, and the recognition target can be recognized with high reliability. Therefore, an effect given by switching the sensor (or the recognition unit) to be activated is expected to be increased. Similarly, the imaging unit 302 (as an example of the third sensor) is desirably attached to a position closer to the recognition target than the imaging units 201a and 201b (as examples of the first sensor) on the user's body.

As an example, in an embodiment of the present disclosure, a case is mainly assumed in which the imaging units 201a and 201b (as examples of the first sensor) are worn on the head (as an example of a first part), the imaging unit 301 (as an example of the second sensor) is worn on a predetermined part (in particular, the palm side) (as an example of a second part different from the first part) of the upper limb part, the imaging unit 302 (as an example of the third sensor) is worn on a predetermined part (in particular, the hand back side) (as an example of a third part different from the first part) of the upper limb part, and the recognition target is a part (in particular a finger) on a terminal side from the predetermined part in the upper limb part. However, the body part of the user to which each of these sensors is worn is not limited. Note that the upper limb part can mean a part (for example, any of an arm, a hand, or a finger) beyond the shoulder in the user's body.

As described above, the activation control unit 123 controls switching of the operation unit to be activated on the basis of a detection result of the wearable device 30 (as an example of the detection target). Hereinafter, a case is mainly assumed in which a detection result of the wearable device 30 detected by the wearable device position/orientation integration unit 113 is used by the activation control unit 123 on the basis of data (an imaging result) obtained by the IR imaging unit 201d of the input/output device 20. More specifically, a direction of the IR imaging unit 201d changes with a direction of the input/output device 20 (the imaging units 201a and 201b). Therefore, a position of the wearable device 30 based on data obtained by the IR imaging unit 201d is detected as a detection position by the wearable device position/orientation integration unit 113 as a relative position of the wearable device 30 with respect to a position of the input/output device 20. However, the method of detecting the wearable device 30 is not limited to such an example.

For example, on the basis of data obtained by the inertial measurement unit 303 of the wearable device 30, the detection result of the wearable device 30 detected by the wearable device position/orientation integration unit 113 may be used by the activation control unit 123. More specifically, the relative position of the wearable device 30 (calculated by the inertial integration calculation unit 111 on the basis of data obtained by the inertial measurement unit 303 of the wearable device 30) with reference to the position of the input/output device 20 (calculated by the inertial integration calculation unit 121 on the basis of data obtained by the inertial measurement unit 220 of the input/output device 20) may be detected as the detection position by the wearable device position/orientation integration unit 113.

Alternatively, a detection result of the wearable device 30 detected on the basis of data obtained by a magnetic sensor may be used by the activation control unit 123. More specifically, in a case where a device (for example, a magnet or the like) that generates a magnetic field is provided in the wearable device 30, and a magnetic sensor (for example, a detection coil or the like) that detects a magnetic flux is provided in the input/output device 20, an arrival direction (that is, a direction in which the wearable device 30 is present with reference to the position of the input/output device 20) of the magnetic field detected by the magnetic sensor may be detected as the detection position.

Alternatively, a detection result of the wearable device 30 detected on the basis of data obtained by an ultrasonic sensor may be used by the activation control unit 123. More specifically, in a case where a device that generates an ultrasonic wave is provided in the wearable device 30, and an ultrasonic sensor that detects the ultrasonic wave is provided in the input/output device 20, an arrival direction (that is, a direction in which the wearable device 30 is present with reference to the position of the input/output device 20) of the ultrasonic wave detected by the ultrasonic sensor may be detected as the detection position.

### 6.1. Basic Control

First, basic control by the activation control unit 123 will be described. FIG. 10 is a view illustrating an example of a field of view of the IR imaging unit 201d of the input/output device 20. Referring to FIG. 10, a field of view 1201 (FoV) of the IR imaging unit 201d is illustrated. The activation control unit 123 controls switching of the operation unit to be activated on the basis of a detection result of the wearable device 30. More specifically, the activation control unit 123 controls switching of the operation unit to be activated on the basis of a positional relationship between the field of view 1201 of the IR imaging unit 201d and a detection position of the wearable device 30.

A region outside the field of view 1201 is an outer region E3. Moreover, referring to FIG. 10, in addition to the outer region E3 and the field of view 1201, a region (hereinafter, also referred to as a “central region E1”) based on a center of the field of view 1201 is illustrated, and a region inside the outer region E3 and outside the central region E1 (hereinafter, also referred to as a “buffer region E2”) is illustrated. Furthermore, a boundary 1202 between the central region E1 and the buffer region E2 is illustrated. In the example illustrated in FIG. 10, a horizontal field of view of the field of view 1201 is 100 degrees, a vertical field of view of the field of view 1201 is 80 degrees, a horizontal field of view of the boundary 1202 is 75 degrees, and a vertical field of view of the boundary 1202 is 60 degrees. However, the specific values of the horizontal field of view and the vertical field of view are not limited.

Note that the region inside the field of view 1201 (that is, the central region E1 and the buffer region E2) is an example of a region (a first region) according to a direction of a part (the head) on which the input/output device 20 is worn. Therefore, instead of the region inside the field of view 1201, another region (for example, a partial region set in a region inside field of view 1201) according to the direction of the part (the head) on which the input/output device 20 is worn may be used. At this time, in the example illustrated in FIG. 10, the region inside the field of view 1201 is a rectangular region, but the shape of the region to be used instead of the region inside the field of view 1201 is not necessarily a rectangular region.

Similarly, the central region E1 is an example of a region (a second region) corresponding to the direction of the part (the head) on which the input/output device 20 is worn. Therefore, instead of the central region E1, another region according to the direction of the part (the head) on which the input/output device 20 is worn may be used. At this time, in the example illustrated in FIG. 10, the central region E1 is a rectangular region, but the shape of the region to be used instead of the central region E1 is not necessarily a rectangular region. Furthermore, in the example illustrated in FIG. 10, a center of the boundary 1202 and a center of the field of view 1201 coincide with each other. However, as will be described later, the center of the boundary 1202 and the center of the field of view 1201 may not coincide with each other.

Here, a case is assumed in which the activation control unit 123 determines that a detection position of the wearable device 30 is within the central region E1. In such a case, the activation control unit 123 turns ON (starts power supply to) the imaging units 201a and 201b, the stereo depth calculation unit 101, and the finger joint recognition unit 103 of the input/output device 20, and turns OFF (stops power supply to) the imaging units 301 and 302 and the finger joint recognition units 115 and 117 of the wearable device 30. Note that the IR imaging unit 201d of the input/output device 20 is always ON regardless of such control (because it is used for detection of the wearable device 30).

Whereas, a case is assumed in which the activation control unit 123 determines that a detection position of the wearable device 30 is within the outer region E3. In such a case, the activation control unit 123 turns OFF (stops power supply to) the imaging units 201a and 201b, the stereo depth calculation unit 101, and the finger joint recognition unit 103 of the input/output device 20, and turns ON (starts power supply to) the imaging units 301 and 302 and the finger joint recognition units 115 and 117 of the wearable device 30. Note that a case is also assumed in which the imaging units 201a and 201b of the input/output device 20 are used for purposes other than finger joint recognition (for example, the SLAM or the like). In such a case, the activation control unit 123 may simply turn OFF only the stereo depth calculation unit 101 and the finger joint recognition unit 103 without turning OFF the imaging units 201a and 201b.

Moreover, a case is assumed in which the activation control unit 123 determines that a detection position of the wearable device 30 is within the buffer region E2. In such a case, the activation control unit 123 turns ON the imaging units 201a and 201b, the stereo depth calculation unit 101, and the finger joint recognition unit 103 of the input/output device 20, and the imaging units 301 and 302 and the finger joint recognition units 115 and 117 of the wearable device 30. As a result, it becomes possible to prevent generation of a period in which data (imaging results) cannot be obtained from the imaging units 201a and 201b of the input/output device 20 or from the imaging units 301 and 302 of the wearable device 30 (since another imaging unit is turned ON before one imaging unit is turned OFF, for example, even in a case where it takes time to initialize the imaging unit at a time of switching between ON and OFF of the imaging units).

Note that, as described above, it is desirable to provide the buffer region E2 (the third region), but a case where the buffer region E2 is not provided can also be assumed. In such a case, the field of view 1201 and the boundary 1202 may not be particularly distinguished (for example, the case where the detection position of the wearable device 30 is within the buffer region E2 may simply be treated similarly to the case where the detection position of the wearable device 30 is within the central region E1).

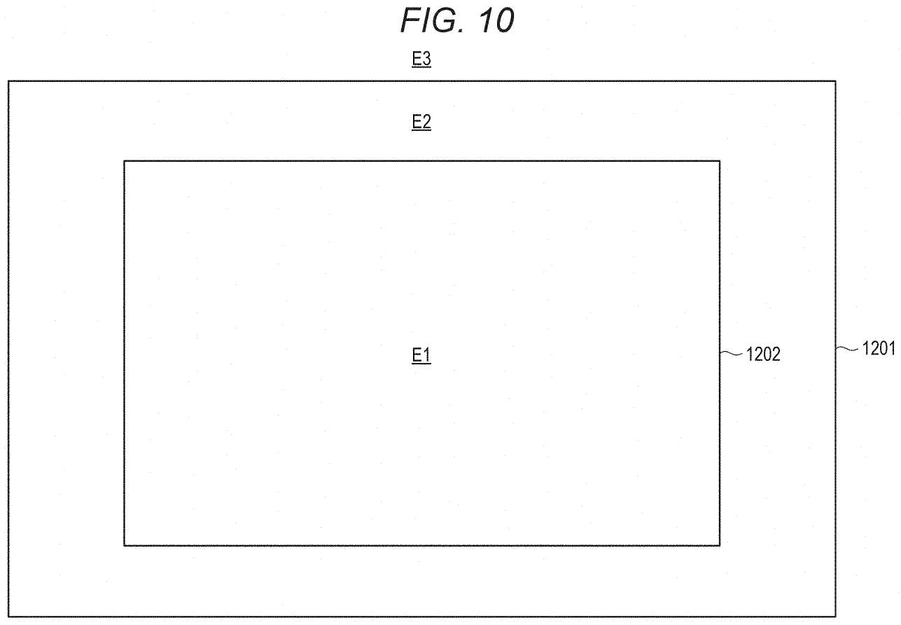

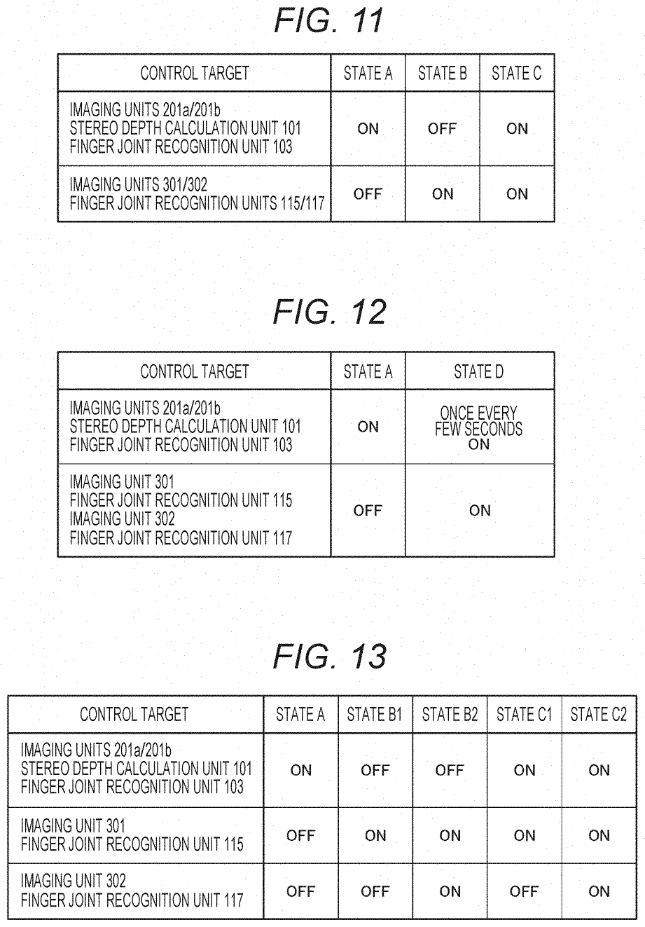

Next, basic control by the activation control unit 123 will be described in an organized manner for every state. FIG. 11 is a table in which basic control by the activation control unit 123 is organized for every state. In the example illustrated in FIG. 11, “state A” indicates a state where it is determined that a detection position of the wearable device 30 is within the central region E1 (FIG. 10). In the “state A”, the imaging units 201a and 201b, the stereo depth calculation unit 101, and the finger joint recognition unit 103 are ON, and the imaging units 301 and 302, and the finger joint recognition units 115 and 117 are OFF.

Whereas, “state B” indicates a state where it is determined that a detection position of the wearable device 30 is within the outer region E3 (FIG. 10). In the “state B”, the imaging units 201a and 201b, the stereo depth calculation unit 101, and the finger joint recognition unit 103 are OFF, and the imaging units 301 and 302, and the finger joint recognition units 115 and 117 are ON.

Moreover, “state C” indicates a case where it is determined that a detection position of the wearable device 30 is within the buffer region E2 (FIG. 10). In the “state C”, the imaging units 201a and 201b, the stereo depth calculation unit 101, the finger joint recognition unit 103, the imaging units 301 and 302, and the finger joint recognition units 115 and 117 are ON. An initial state is assumed to be the “state A”.

At this time, a case is assumed in which the activation control unit 123 detects that a detection position of the wearable device 30 is within the outer region E3. In such a case, the activation control unit 123 causes a current state to be shifted from the “state A” to the “state B” on the basis of such detection. Whereas, a case is assumed in which the activation control unit 123 detects that a detection position of the wearable device 30 is within the buffer region E2 when the current state is the “state A”. In such a case, the activation control unit 123 causes the current state to be shifted from the “state A” to the “state C” on the basis of such detection.

Subsequently, a case is assumed in which the activation control unit 123 detects that a detection position of the wearable device 30 has moved to the central region E1 when the current state is the “state B”. In such a case, the activation control unit 123 causes the current state to be shifted from the “state B” to the “state A” on the basis of such a movement. Whereas, a case is assumed in which the activation control unit 123 detects that a detection position of the wearable device 30 has moved to the buffer region E2 when the current state is the “state B”. In such a case, the activation control unit 123 causes the current state to be shifted from the “state A” to the “state C” on the basis of such a movement.

Subsequently, a case is assumed in which the activation control unit 123 detects that a detection position of the wearable device 30 has moved to the central region E1 when the current state is the “state C”. In such a case, the activation control unit 123 causes the current state to be shifted from the “state C” to the “state A” on the basis of such a movement. Whereas, a case is assumed in which the activation control unit 123 detects that a detection position of the wearable device 30 has moved to the outer region E3 when the current state is the “state C”. In such a case, the activation control unit 123 causes the current state to be shifted from the “state C” to the “state B” on the basis of such a movement.

As described above, in a case where it is effective to use the input/output device 20 with a smaller power constraint, the activation control unit 123 turns ON the imaging units 201a and 201b, the stereo depth calculation unit 101, and the finger joint recognition unit 103, and turns OFF the imaging units 301 and 302 and the finger joint recognition units 115 and 117. Whereas, in a case where it is not effective to use the input/output device 20, the activation control unit 123 turns OFF the imaging units 201a and 201b, the stereo depth calculation unit 101, and the finger joint recognition unit 103, and turns ON the imaging units 301 and 302 and the finger joint recognition units 115 and 117. As a result, it becomes possible to robustly recognize a finger joint position while reducing the power consumption required for recognizing the finger joint position.

Note that a position of the boundary 1202 may be variable. For example, the activation control unit 123 may adjust the position of the boundary 1202 on the basis of a relative speed (as viewed from the imaging unit 201) of the wearable device 30. As an example, in a case where the relative speed of the wearable device 30 with respect to the imaging unit 201 is higher than a first speed, the activation control unit 123 may bring the boundary 1202 close to a center of the field of view 1201 (since the buffer region E2 is preferably larger). Whereas, in a case where the relative speed of the wearable device 30 with respect to the imaging unit 201 is lower than a second speed, the activation control unit 123 may keep the boundary 1202 away from the center of the field of view 1201 (because the buffer region E2 may be small).

Furthermore, in the example described above, the detection position of the wearable device 30 is directly used, but the activation control unit 123 may use a position (a prediction position) predicted on the basis of the detection position instead of the detection position of the wearable device 30. For example, on the basis of the detection position of the wearable device 30 and the relative speed (as viewed from the imaging unit 201) of the wearable device 30, the activation control unit 123 may predict a position of the wearable device 30 after a certain period of time (for example, 16.6 milliseconds) has elapsed, and use the prediction position (the prediction position) instead of the detection position of the wearable device 30.

### 6.2. Control Based on Reliability on Input/Output Device Side

Next, control by the activation control unit 123 based on reliability on the input/output device side will be described. Here, a case is assumed in which the activation control unit 123 determines that a detection position of the wearable device 30 is within the central region E1. However, even in such a case, it is also assumed that reliability of a finger joint position recognized by the finger joint recognition unit 103 on the basis of data obtained by the imaging units 201a and 201b of the input/output device 20 is lower than a first threshold value. In such a case, a situation is assumed in which the user's finger is hidden by self-occlusion or other occlusion when viewed from the imaging units 201a and 201b.

Alternatively, even in a case where it is determined that a detection position of the wearable device 30 is within the central region E1, a case is also assumed in which the relative position/orientation R2 (FIG. 4) (as viewed from the imaging unit 201) of the wearable device 30 satisfies a first condition (for example, a case where an angle formed by a surface of the controller unit 31 to which the optical marker 320 is attached and a direction of the imaging unit 201 is smaller than a first angle). In such a case, a situation is assumed in which it is difficult to accurately recognize the user's finger on the basis of data obtained by the imaging units 201a and 201b.

Therefore, in a case where the reliability of the finger joint position recognized by the finger joint recognition unit 103 is lower than the first threshold value, or in a case where the relative position/orientation R2 (FIG. 4) (as viewed from the imaging unit 201) of the wearable device 30 satisfies the first condition, the activation control unit 123 turns OFF the imaging units 201a and 201b, the stereo depth calculation unit 101, and the finger joint recognition unit 103 of the input/output device 20, and turns ON the imaging units 301 and 302 and the finger joint recognition units 115 and 117 of the wearable device 30.

Note that a case is also assumed in which the imaging units 201a and 201b of the input/output device 20 are used for purposes other than finger joint recognition (for example, the SLAM or the like). In such a case, the activation control unit 123 may simply turn OFF only the stereo depth calculation unit 101 and the finger joint recognition unit 103 without turning OFF the imaging units 201a and 201b.

However, the activation control unit 123 turns ON the imaging units 201a and 201b, the stereo depth calculation unit 101, and the finger joint recognition unit 103 of the input/output device 20 at a predetermined time interval (for example, once every few seconds, or the like). As a result, the activation control unit 123 acquires the reliability of the finger joint position recognized by the finger joint recognition unit 103 on the basis of data obtained by the imaging units 201a and 201b of the input/output device 20.

In a case where the reliability of the finger joint position recognized by the finger joint recognition unit 103 is higher than a second threshold value, or in a case where the relative position/orientation R2 (FIG. 4) (as viewed from the imaging unit 201) of the wearable device 30 satisfies a second condition (for example, in a case where an angle formed by a surface of the controller unit 31 to which the optical marker 320 is attached and a direction of the imaging unit 201 is larger than a second angle), the activation control unit 123 keeps the imaging units 201a and 201b, the stereo depth calculation unit 101, and the finger joint recognition unit 103 of the input/output device 20 to be ON, and turns OFF the imaging units 301 and 302 and the finger joint recognition units 115 and 117 of the wearable device 30.

Whereas, in a case where the reliability of the finger joint position recognized by the finger joint recognition unit 103 is equal to or less than the second threshold value, and the relative position/orientation R2 (FIG. 4) of the wearable device 30 (as viewed from the imaging unit 201) does not satisfy the second condition, the activation control unit 123 turns OFF again the imaging units 201a and 201b, the stereo depth calculation unit 101, and the finger joint recognition unit 103 of the input/output device 20. Note that the first threshold value and the second threshold value may be the same or different. Similarly, the first angle and the second angle may be the same or different.

Next, control by the activation control unit 123 based on reliability will be described in an organized manner for every state. FIG. 12 is a table in which control by the activation control unit 123 based on reliability is organized for every state. In the example illustrated in FIG. 12, each of “state A” and “state D” indicates a state where it is determined that a detection position of the wearable device 30 is within the central region E1 (FIG. 10).

In the “state A”, the imaging units 201a and 201b, the stereo depth calculation unit 101, and the finger joint recognition unit 103 are ON, and the imaging units 301 and 302, and the finger joint recognition units 115 and 117 are OFF. Whereas, in the “state D”, the imaging units 201a and 201b, the stereo depth calculation unit 101, and the finger joint recognition unit 103 are OFF, and the imaging units 301 and 302, and the finger joint recognition units 115 and 117 are ON, but the imaging units 201a and 201b, the stereo depth calculation unit 101, and the finger joint recognition unit 103 of the input/output device 20 are turned ON at a predetermined time interval (for example, once every few seconds, or the like).

It is assumed that, when the current state is the “state A”, the activation control unit 123 determines as a case where the reliability of the finger joint position recognized by the finger joint recognition unit 103 is lower than the first threshold value, or a case where the relative position/orientation R2 (FIG. 4) (as viewed from the imaging unit 201) of the wearable device 30 satisfies the first condition. In such a case, the activation control unit 123 causes the current state to be shifted from the “state A” to the “state D”.

Whereas, it is assumed that, when the current state is the “state D”, the activation control unit 123 determines as a case where the reliability of the finger joint position recognized by the finger joint recognition unit 103 is higher than the second threshold value, or a case where the relative position/orientation R2 (FIG. 4) (as viewed from the imaging unit 201) of the wearable device 30 satisfies the second condition. In such a case, the activation control unit 123 causes the current state to be shifted from the “state D” to the “state A”.

### 6.3. Control Based on Reliability on Wearable Device Side

Next, control by the activation control unit 123 based on reliability on the wearable device side will be described. Here, a case is assumed in which the activation control unit 123 determines that a detection position of the wearable device 30 is within the outer region E3 or the buffer region E2. However, even in such a case, it is also assumed that the reliability of the finger joint position recognized by the finger joint recognition unit 103 on the basis of data obtained by the imaging unit 301 of the wearable device 30 is lower than a third threshold value. At this time, it is considered desirable that the imaging unit 302 of the wearable device 30 is also turned ON in order to more accurately recognize the finger joint position.

Whereas, a case is also assumed in which the reliability of the finger joint position recognized by the finger joint recognition unit 103 on the basis of data obtained by the imaging unit 301 of the wearable device 30 is higher than a fourth threshold value. At this time, it is considered that the imaging unit 302 of the wearable device 30 may be turned OFF in order to reduce power consumption. As a result, it is possible to suppress a decrease in recognition accuracy of the finger joint position while reducing the power consumption required to recognize the finger joint position.

(Detection Position is within Outer Region E3)

Here, a case is assumed in which the activation control unit 123 determines that a detection position of the wearable device 30 is within the outer region E3. In such a case, the activation control unit 123 turns OFF (stops power supply to) the imaging units 201a and 201b, the stereo depth calculation unit 101, and the finger joint recognition unit 103 of the input/output device 20, and turns ON (starts power supply to) the imaging unit 301 and the finger joint recognition unit 115 of the wearable device 30. However, the activation control unit 123 temporarily turns OFF the imaging unit 302 and the finger joint recognition unit 117 of the wearable device 30.

Note that a case is also assumed in which the imaging units 201a and 201b of the input/output device 20 are used for purposes other than finger joint recognition (for example, the SLAM or the like). In such a case, the activation control unit 123 may simply turn OFF only the stereo depth calculation unit 101 and the finger joint recognition unit 103 without turning OFF the imaging units 201a and 201b.

Then, the activation control unit 123 acquires the reliability of the finger joint position recognized by the finger joint recognition unit 115 on the basis of data obtained by the imaging unit 301 of the wearable device 30. In a case where the imaging unit 302 and the finger joint recognition unit 117 are turned OFF, and the reliability of the finger joint position recognized by the finger joint recognition unit 115 is lower than the third threshold value, the activation control unit 123 turns ON the imaging unit 302 and the finger joint recognition unit 117 of the wearable device 30. Whereas, in a case where the imaging unit 302 and the finger joint recognition unit 117 are ON, and the reliability of the finger joint position recognized by the finger joint recognition unit 115 is higher than the fourth threshold value, the activation control unit 123 turns OFF the imaging unit 302 and the finger joint recognition unit 117 of the wearable device 30.

Note that the third threshold value and the fourth threshold value may be the same or different. Moreover, switching between ON and OFF of the imaging unit 302 and the finger joint recognition unit 117 of the wearable device 30 may have downtime. That is, in a case where the imaging unit 302 and the finger joint recognition unit 117 of the wearable device 30 are switched from ON to OFF, the activation control unit 123 may not turn ON again the imaging unit 302 and the finger joint recognition unit 117 of the wearable device 30 until a certain period of time elapses, regardless of the reliability of the finger joint position recognized by the finger joint recognition unit 115.

(Detection Position is within Buffer Region E2)

A case is assumed in which the activation control unit 123 determines that a detection position of the wearable device 30 is within the buffer region E2. In such a case, the activation control unit 123 turns ON the imaging units 201a and 201b, the stereo depth calculation unit 101, and the finger joint recognition unit 103 of the input/output device 20, and the imaging units 301 and 302 and the finger joint recognition units 115 and 117 of the wearable device 30. As a result, as described above, it becomes possible to prevent generation of a period in which data (imaging results) cannot be obtained from the imaging units 201a and 201b of the input/output device 20 or from the imaging units 301 and 302 of the wearable device 30.

Moreover, in a case where it is determined that a detection position of the wearable device 30 is within the buffer region E2, the activation control unit 123 turns OFF (stops power supply to) the imaging units 201a and 201b, the stereo depth calculation unit 101, and the finger joint recognition unit 103 of the input/output device 20, and turns ON (starts power supply to) the imaging unit 301 and the finger joint recognition unit 115 of the wearable device 30. However, the activation control unit 123 temporarily turns OFF the imaging unit 302 and the finger joint recognition unit 117 of the wearable device 30.

Note that a case is also assumed in which the imaging units 201a and 201b of the input/output device 20 are used for purposes other than finger joint recognition (for example, the SLAM or the like). In such a case, the activation control unit 123 may simply turn OFF only the stereo depth calculation unit 101 and the finger joint recognition unit 103 without turning OFF the imaging units 201a and 201b.

Then, similarly to the case where the detection position of the wearable device 30 is within the outer region E3, the activation control unit 123 turns ON the imaging unit 302 and the finger joint recognition unit 117 of the wearable device 30 in a case where the imaging unit 302 and the finger joint recognition unit 117 are OFF, and where the reliability of the finger joint position recognized by the finger joint recognition unit 115 is lower than the third threshold value. Whereas, in a case where the imaging unit 302 and the finger joint recognition unit 117 are ON, and the reliability of the finger joint position recognized by the finger joint recognition unit 115 is higher than the fourth threshold value, the activation control unit 123 turns OFF the imaging unit 302 and the finger joint recognition unit 117 of the wearable device 30.

(Organizing for Every State)

Next, control by the activation control unit 123 based on reliability on the wearable device side will be described in an organized manner for every state. FIG. 13 is a table in which control by the activation control unit 123 based on reliability on the wearable device side is organized for every state. In the example illustrated in FIG. 13, “state A” indicates a state where it is determined that a detection position of the wearable device 30 is within the central region E1 (FIG. 10). “State B1” and “state B2” indicate a state where it is determined that a detection position of the wearable device 30 is within the outer region E3 (FIG. 10). “State C1” and “state C2” indicate a state where it is determined that a detection position of the wearable device 30 is within the buffer region E2 (FIG. 10).

In the “state A”, the imaging units 201a and 201b, the stereo depth calculation unit 101, and the finger joint recognition unit 103 are ON, and the imaging units 301 and 302, and the finger joint recognition units 115 and 117 are OFF.

In the “state B1”, the imaging units 201a and 201b, the stereo depth calculation unit 101, and the finger joint recognition unit 103 are OFF, and the imaging unit 301 and the finger joint recognition unit 115 are ON, but the imaging unit 302 and the finger joint recognition unit 117 are OFF. In the “state B2”, the imaging units 201a and 201b, the stereo depth calculation unit 101, and the finger joint recognition unit 103 are OFF, the imaging unit 301 and the finger joint recognition unit 115 are ON, and the imaging unit 302 and the finger joint recognition unit 117 are also ON.

In the “state C1”, the imaging units 201a and 201b, the stereo depth calculation unit 101, and the finger joint recognition unit 103 are ON, and the imaging unit 301 and the finger joint recognition unit 115 are ON, but the imaging unit 302 and the finger joint recognition unit 117 are OFF. In the “state C2”, the imaging units 201a and 201b, the stereo depth calculation unit 101, and the finger joint recognition unit 103 are ON, the imaging unit 301 and the finger joint recognition unit 115 are ON, and the imaging unit 302 and the finger joint recognition unit 117 are also ON. An initial state is assumed to be the “state A”.

It is assumed that the activation control unit 123 determines that a detection position of the wearable device 30 is within the outer region E3 when the current state is the “state A”. In such a case, the activation control unit 123 causes the current state to be shifted from the “state A” to the “state B1”. Whereas, it is assumed that the activation control unit 123 determines that a detection position of the wearable device 30 is within the buffer region E2 when the current state is the “state A”. In such a case, the activation control unit 123 causes the current state to be shifted from the “state A” to the “state C1”.

In a case where the reliability of the finger joint position recognized by the finger joint recognition unit 115 falls below the third threshold value when the current state is the “state B1”, the activation control unit 123 causes the current state to be shifted from the “state B1” to the “state B2”. Whereas, in a case where the reliability of the finger joint position recognized by the finger joint recognition unit 115 exceeds the fourth threshold value when the current state is the “state B2”, the activation control unit 123 causes the current state to be shifted from the “state B2” to the “state B1”.

Similarly, in a case where the reliability of the finger joint position recognized by the finger joint recognition unit 115 falls below the third threshold value when the current state is the “state C1”, the activation control unit 123 causes the current state to be shifted from the “state C1” to the “state C2”. Whereas, in a case where the reliability of the finger joint position recognized by the finger joint recognition unit 115 exceeds the fourth threshold value when the current state is the “state C2”, the activation control unit 123 causes the current state to be shifted from the “state C2” to the “state C1”.

A case is assumed in which the activation control unit 123 detects that a detection position of the wearable device 30 has moved to the central region E1 when the current state is the “state B1” or the “state B2”. In such a case, the activation control unit 123 causes the current state to be shifted from the “state B1” or the “state B2” to the “state A”. Whereas, a case is assumed in which the activation control unit 123 detects that a detection position of the wearable device 30 has moved to the buffer region E2 when the current state is the “state B1” or the “state B2”. In such a case, the activation control unit 123 causes the current state to be shifted from the “state B1” or the “state B2” to the “state C1”.

A case is assumed in which the activation control unit 123 detects that a detection position of the wearable device 30 has moved to the central region E1 when the current state is the “state C1” or the “state C2”. In such a case, the activation control unit 123 causes the current state to be shifted from the “state C1” or the “state C2” to the “state A”. Whereas, a case is assumed in which the activation control unit 123 detects that a detection position of the wearable device 30 has moved to the outer region E3 when the current state is the “state C1” or the “state C2”. In such a case, the activation control unit 123 causes the current state to be shifted from the “state C1” or the “state C2” to the “state B1”.

### 6.4. Control Based on Reliability of Both Devices

Next, an example will be described in which control based on reliability on the input/output device side and control based on reliability on the wearable device side are integrated.

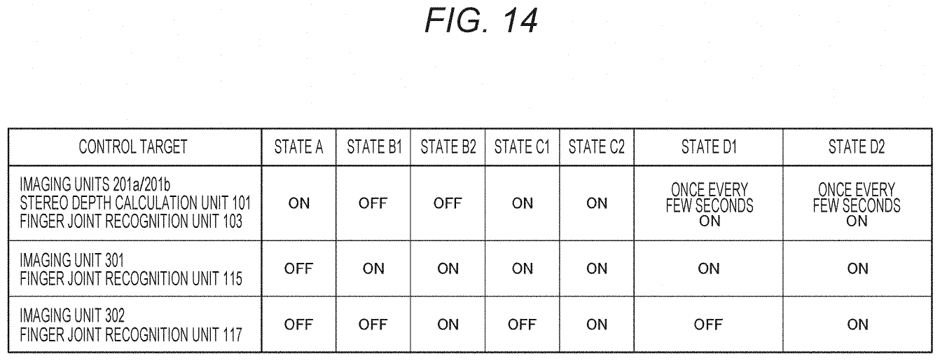

FIG. 14 is a table in which an example of integration of control based on reliability on the input/output device side and control based on reliability on the wearable device side is organized for every state. The example illustrated in FIG. 14 is an example in which the “state D” is also separated into “state D1” and “state D2” after integration of a view illustrated in FIG. 12 in which control based on the reliability on the input/output device side is organized for every state and a view illustrated in FIG. 13 in which control based on the reliability on the wearable device side is organized for every state. An initial state is assumed to be the “state A”.

It is assumed that, when the current state is the “state A”, the activation control unit 123 determines as a case where the reliability of the finger joint position recognized by the finger joint recognition unit 103 is lower than the first threshold value, or a case where a relative position/orientation (FIG. 4) (as viewed from the imaging unit 201) of the wearable device 30 satisfies the first condition. In such a case, the activation control unit 123 causes the current state to be shifted from the “state A” to the “state D1”.

Whereas, it is assumed that, when the current state is the “state D1”, the activation control unit 123 determines as a case where the reliability of the finger joint position recognized by the finger joint recognition unit 103 is higher than the second threshold value, or a case where the relative position/orientation R2 (FIG. 4) (as viewed from the imaging unit 201) of the wearable device 30 satisfies the second condition. In such a case, the activation control unit 123 causes the current state to be shifted from the “state D1” to the “state A”. In a case where the reliability of the finger joint position recognized by the finger joint recognition unit 115 falls below the third threshold value when the current state is “state D1”, the activation control unit 123 causes the current state to be shifted from the “state D1” to the “state D2”.

Whereas, it is assumed that, when the current state is the “state D2”, the activation control unit 123 determines as a case where the reliability of the finger joint position recognized by the finger joint recognition unit 103 is higher than the second threshold value, or a case where the relative position/orientation R2 (FIG. 4) (as viewed from the imaging unit 201) of the wearable device 30 satisfies the second condition. In such a case, the activation control unit 123 causes the current state to be shifted from the “state D2” to the “state A”. In a case where the reliability of the finger joint position recognized by the finger joint recognition unit 115 exceeds the fourth threshold value when the current state is “state D2”, the activation control unit 123 causes the current state to be shifted from the “state D2” to the “state D1”.

It is assumed that the activation control unit 123 determines that a detection position of the wearable device 30 is within the outer region E3 when the current state is the “state A”, the “state D1”, or the “state D2”. In such a case, the activation control unit 123 causes the current state to be shifted to the “state B1”. Whereas, it is assumed that the activation control unit 123 determines that a detection position of the wearable device 30 is within the buffer region E2 when the current state is the “state A”, the “state D1”, or the “state D2”. In such a case, the activation control unit 123 causes the current state to be shifted to the “state C1”.

In a case where the reliability of the finger joint position recognized by the finger joint recognition unit 115 falls below the third threshold value when the current state is the “state B1”, the activation control unit 123 causes the current state to be shifted from the “state B1” to the “state B2”. In a case where the reliability of the finger joint position recognized by the finger joint recognition unit 115 exceeds the fourth threshold value when the current state is the “state B2”, the activation control unit 123 causes the current state to be shifted from the “state B2” to the “state B1”.

It is assumed that the activation control unit 123 determines that a detection position of the wearable device 30 is within the central region E1 when the current state is the “state B1” or the “state B2”. In such a case, the activation control unit 123 causes the current state to be shifted to the “state A”. Whereas, it is assumed that the activation control unit 123 determines that a detection position of the wearable device 30 is within the buffer region E2 when the current state is the “state B1” or the “state B2”. In such a case, the activation control unit 123 causes the current state to be shifted to the “state C1”.

In a case where the reliability of the finger joint position recognized by the finger joint recognition unit 115 falls below the third threshold value when the current state is the “state C1”, the activation control unit 123 causes the current state to be shifted from the “state C1” to the “state C2”. In a case where the reliability of the finger joint position recognized by the finger joint recognition unit 115 exceeds the fourth threshold value when the current state is the “state C2”, the activation control unit 123 causes the current state to be shifted from the “state C2” to the “state C1”.

It is assumed that the activation control unit 123 determines that a detection position of the wearable device 30 is within the central region E1 when the current state is the “state C1” or the “state C2”. In such a case, the activation control unit 123 causes the current state to be shifted to the “state A”. Whereas, it is assumed that the activation control unit 123 determines that a detection position of the wearable device 30 is within the outer region E3 when the current state is the “state C1” or the “state C2”. In such a case, the activation control unit 123 causes the current state to be shifted to the “state B1”.

The notable features of one embodiment of the present disclosure have been described above.

### 7. Hardware Configuration Example

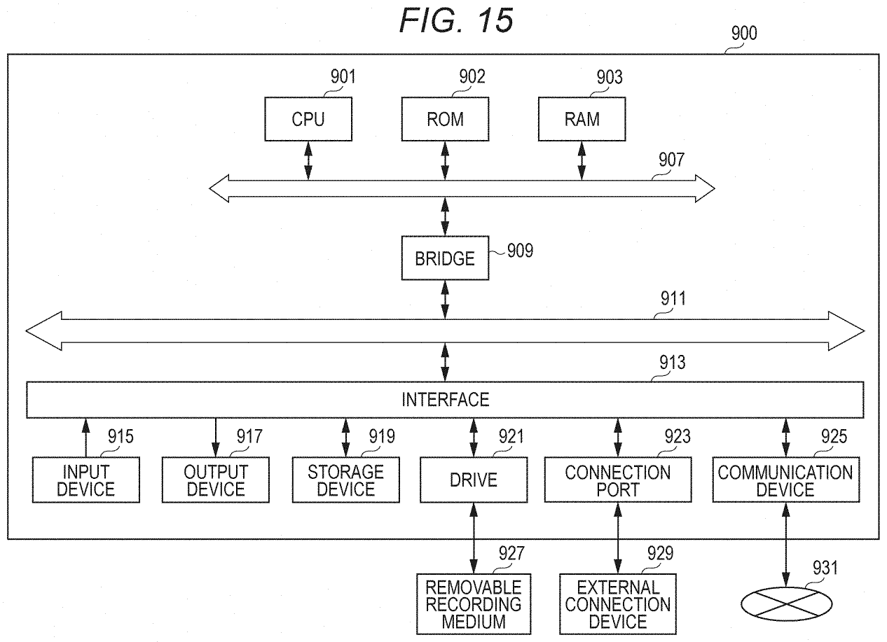

Subsequently, with reference to FIG. 15, a detailed description will be given to an example of a hardware configuration of various information processing devices constituting the information processing system 1 according to an embodiment of the present disclosure, as in the information processing device 10, the input/output device 20, and the wearable device 30 described above. FIG. 15 is a functional block diagram illustrating a configuration example of a hardware configuration of various information processing devices constituting the information processing system 1 according to an embodiment of the present disclosure.

An information processing device 900 constituting the information processing system 1 according to the present embodiment mainly includes a central processing unit (CPU) 901, a read only memory (ROM) 902, and a random access memory (RAM) 903. Furthermore, the information processing device 900 further includes a host bus 907, a bridge 909, an external bus 911, an interface 913, an input device 915, an output device 917, a storage device 919, a drive 921, a connection port 923, and a communication device 925.

The CPU 901 functions as an arithmetic processing device and a control device, and controls an overall operation or a part thereof in the information processing device 900, in accordance with various programs recorded in the ROM 902, the RAM 903, the storage device 919, or a removable recording medium 927. The ROM 902 stores a program, operation parameters, and the like used by the CPU 901. The RAM 903 primarily stores a program used by the CPU 901, parameters that appropriately change in execution of the program, and the like. These are mutually connected by the host bus 907 including an internal bus such as a CPU bus. For example, each block included in the information processing device 10 illustrated in FIG. 5 can be configured by the CPU 901.

The host bus 907 is connected to the external bus 911 such as a peripheral component interconnect/interface (PCI) bus via the bridge 909. Furthermore, the input device 915, the output device 917, the storage device 919, the drive 921, the connection port 923, and the communication device 925 are connected to the external bus 911 via the interface 913.

The input device 915 is an operation means operated by the user, such as, for example, a mouse, a keyboard, a touch panel, a button, a switch, a lever, and a pedal. Furthermore, the input device 915 may be, for example, a remote control means (a so-called remote controller) using infrared rays or other radio waves, or an external connection device 929 such as a mobile phone or a PDA corresponding to an operation of the information processing device 900. Moreover, the input device 915 includes, for example, an input control circuit or the like that generates an input signal on the basis of information inputted by the user using the above-described operation means and outputs the input signal to the CPU 901. By operating the input device 915, the user of the information processing device 900 can input various types of data or give an instruction to perform a processing operation, to the information processing device 900.

The output device 917 includes a device capable of visually or auditorily notifying the user of acquired information. Examples of such a device include a display device such as a CRT display device, a liquid crystal display device, a plasma display device, an EL display device, and a lamp, a voice output device such as a speaker and a headphone, a printer device, and the like. The output device 917 outputs, for example, results obtained by various types of processing performed by the information processing device 900. Specifically, the display device displays results obtained by various types of processing performed by the information processing device 900 as text or images. Whereas, a voice output device converts an audio signal including reproduced voice data, audio data, or the like into an analog signal and outputs the analog signal. For example, the output unit 210 illustrated in FIG. 5 can be configured by the output device 917.

The storage device 919 is a data storage device configured as an example of a storage unit of the information processing device 900. The storage device 919 includes, for example, a magnetic storage unit device such as a hard disk drive (HDD), a semiconductor storage device, an optical storage device, a magneto-optical storage device, or the like. The storage device 919 stores a program executed by the CPU 901, various data, and the like. For example, the storage unit 190 illustrated in FIG. 5 can be configured by the storage device 919.

The drive 921 is a reader/writer for a recording medium, and is built in or externally attached to the information processing device 900. The drive 921 reads information recorded on the mounted removable recording medium 927 such as a magnetic disk, an optical disk, a magneto-optical disk, or a semiconductor memory, and outputs the information to the RAM 903. Furthermore, the drive 921 can also write a record on the mounted removable recording medium 927 such as a magnetic disk, an optical disk, a magneto-optical disk, or a semiconductor memory. The removable recording medium 927 is, for example, a DVD medium, an HD-DVD medium, a Blu-ray (registered trademark) medium, or the like. Furthermore, the removable recording medium 927 may be a CompactFlash (CF) (registered trademark), a flash memory, a secure digital (SD) memory card, or the like. Furthermore, the removable recording medium 927 may be, for example, an integrated circuit (IC) card on which a non-contact IC chip is mounted, an electronic device, or the like.

The connection port 923 is a port for directly connecting to the information processing device 900. Examples of the connection port 923 include a universal serial bus (USB) port, an IEEE 1394 port, a small computer system interface (SCSI) port, and the like. Other examples of the connection port 923 include an RS-232C port, an optical audio terminal, a high-definition multimedia interface (HDMI) (registered trademark) port, and the like. By connecting the external connection device 929 to the connection port 923, the information processing device 900 directly acquires various data from the external connection device 929 or provides various data to the external connection device 929.

The communication device 925 is, for example, a communication interface including a communication device or the like for connecting to a communication network (network) 931. The communication device 925 is, for example, a communication card or the like for wired or wireless local area network (LAN), Bluetooth (registered trademark), or wireless USB (WUSB). Furthermore, the communication device 925 may be a router for optical communication, a router for asymmetric digital subscriber line (ADSL), a modem for various communications, or the like. For example, the communication device 925 can transmit and receive signals and the like to and from the Internet and other communication devices according to a predetermined protocol such as TCP/IP. Furthermore, the communication network 931 connected to the communication device 925 includes a network or the like connected in a wired or wireless manner, and may be, for example, the Internet, a home LAN, infrared communication, radio wave communication, satellite communication, or the like.

An example of the hardware configuration capable of realizing the functions of the information processing device 900 constituting the information processing system 1 according to the embodiment of the present disclosure has been described above. Each component described above may be configured using a general-purpose member, or may be configured by hardware specialized for a function of each component. Therefore, it is possible to appropriately change the hardware configuration to be used in accordance with a technical level at the time of carrying out the present embodiment. Note that, although not illustrated in FIG. 15, various configurations corresponding to the information processing device 900 included in the information processing system 1 are naturally included.

Note that a computer program for realizing each function of the information processing device 900 constituting the information processing system according to the present embodiment as described above can be created and implemented on a personal computer or the like. Furthermore, a computer-readable recording medium storing such a computer program can also be provided. The recording medium is, for example, a magnetic disk, an optical disk, a magneto-optical disk, a flash memory, or the like. Furthermore, the computer program described above may be distributed via, for example, a network without using a recording medium. Furthermore, the number of computers that execute the computer program is not particularly limited. For example, a plurality of computers (for example, a plurality of servers and the like) may execute the computer program in cooperation with each other.

An example of the hardware configuration of various information processing devices constituting the information processing system 1 according to an embodiment of the present disclosure has been described above.

### 8. Conclusion

According to an embodiment of the present disclosure, there is provided an information processing device including: a control unit configured to control switching of an operation unit to be activated between a first operation unit and a second operation unit related to recognition of a recognition target existing in a real space, on the basis of a detection result of a detection target, in which a first sensor configured to obtain first data in which the recognition target is recognized is attached to a first part of a body of a user, and a second sensor configured to obtain second data in which the recognition target is recognized is attached to a second part of the body different from the first part.

According to such a configuration, there is provided a technique capable of robustly recognizing a recognition target while reducing power consumption required for recognition of the recognition target.

The preferred embodiment of the present disclosure has been described above in detail with reference to the accompanying drawings, but the technical scope of the present disclosure is not limited to such examples. It is obvious that those with ordinary skill in the technical field of the present disclosure can arrive various variations or modifications within the scope of the technical idea described in the claims, and it is naturally understood that these also fall within the technical scope of the present disclosure.

Furthermore, the effects described in the present specification are merely exemplary or illustrative, and not restrictive. That is, the technology according to the present disclosure can exhibit other effects apparent to those skilled in the art from the description of the present specification, in addition to the effect described above or instead of the effect described above.

Note that the following configurations are also within the technical scope of the present disclosure.

(1)

An information processing device including:

a control unit configured to control switching of an operation unit to be activated between a first operation unit and a second operation unit related to recognition of a recognition target existing in a real space, on the basis of a detection result of a detection target, in which

a first sensor configured to obtain first data in which the recognition target is recognized is attached to a first part of a body of a user, and a second sensor configured to obtain second data in which the recognition target is recognized is attached to a second part of the body different from the first part.

(2)

The information processing device according to (1) above, in which

the first operation unit includes at least any one of the first sensor or a first recognition unit that recognizes the recognition target on the basis of the first data, and

the second operation unit includes at least any one of the second sensor or a second recognition unit that recognizes the recognition target on the basis of the second data.

(3)

The information processing device according to (1) or (2) above, in which

the control unit performs control to stop the second operation unit on the basis of a movement of a detection position of the detection target or a prediction position based on the detection position, from an outside of a first region according to a direction of the first part to an inside of a second region according to a direction of the first part.

(4)

The information processing device according to (3) above, in which

the control unit performs control to activate the first operation unit on the basis of a movement of the detection position or the prediction position from an outside of the first region to an inside of the second region.

(5)

The information processing device according to (3) above, in which

the control unit performs control to activate the first operation unit on the basis of a movement of the detection position or the prediction position from an outside of the first region to an inside a third region that is a region outside the second region in the first region.

(6)

The information processing device according to (3) above, in which

the control unit performs control to stop the first operation unit on the basis of a movement of the detection position or the prediction position from an inside of the second region to an outside of the first region.

(7)

The information processing device according to (6) above, in which

the control unit performs control to activate the second operation unit on the basis of a movement of the detection position or the prediction position from an inside of the second region to an outside of the first region.

(8)

The information processing device according to (6) above, in which

the control unit controls to activate the second operation unit on the basis of a movement of the detection position or the prediction position from an inside of the second region to an inside of a third region that is a region outside the second region in the first region.

(9)

The information processing device according to (2) above, in which

the control unit performs control to activate the second operation unit in a case where reliability of recognition of the recognition target by the first recognition unit is lower than a first threshold value or in a case where a relative position/orientation of the detection target as viewed from the first sensor satisfies a first condition.

(10)

The information processing device according to (9) above, in which

the control unit performs control to activate the second operation unit, and then performs control to stop the second operation unit in a case where reliability of recognition of the recognition target by the first recognition unit is higher than a second threshold value, or in a case where a relative position/orientation of the detection target as viewed from the first sensor satisfies a second condition.

(11)

The information processing device according to (2) above, in which

the control unit performs control to activate a third operation unit in a case where reliability of recognition of the recognition target by the second recognition unit is lower than a third threshold value, in a case where a detection position of the detection target or a prediction position based on the detection position is present outside a first region according to a direction of the first part.

(12)

The information processing device according to any one of (1) to (11) above, in which

the information processing device includes an output control unit configured to control a display unit to display a virtual object operable by the user, on the basis of a recognition result of the recognition target.

(13)

The information processing device according to any one of (1) to (12) above, in which

the second sensor is attached to the body at a position closer to the recognition target than the first sensor.

(14)

The information processing device according to (13) above, in which

the first sensor is worn on a head,

the second sensor is worn on a predetermined part of an upper limb part, and

the recognition target is a part on a terminal side from the predetermined part in the upper limb part.

(15)

The information processing device according to any one of (1) to (14) above, in which

the control unit controls the switching on the basis of a detection result of the detection target based on data obtained by at least any of an imaging unit, an inertial measurement unit, a magnetic sensor, or an ultrasonic sensor.

(16)

The information processing device according to (15) above, in which

the control unit controls the switching on the basis of a field of view of the imaging unit and a detection result of the detection target.

(17)

The information processing device according to (15) above, in which

the control unit controls the switching on the basis of a detection result of the detection target based on data obtained by the imaging unit, and

a direction of the imaging unit changes with a change in a direction of the first sensor.

(18)

The information processing device according to any one of (1) to (17) above, in which

a position of the recognition target changes with a change in a position of the detection target.

(19)

An information processing method including:

controlling, by a processor, switching of an operation unit to be activated between a first operation unit and a second operation unit related to recognition of a recognition target existing in a real space, on the basis of a detection result of a detection target, in which

a first sensor configured to obtain first data in which the recognition target is recognized is attached to a first part of a body of a user, and a second sensor configured to obtain second data in which the recognition target is recognized is attached to a second part of the body different from the first part.

(20)

A program for causing a computer to function as an information processing device including:

a control unit configured to control switching of an operation unit to be activated between a first operation unit and a second operation unit related to recognition of a recognition target existing in a real space, on the basis of a detection result of a detection target, in which

a first sensor configured to obtain first data in which the recognition target is recognized is attached to a first part of a body of a user, and a second sensor configured to obtain second data in which the recognition target is recognized is attached to a second part of the body different from the first part.

### REFERENCE SIGNS LIST

1 Information processing system
10 Information processing device
101 Stereo depth calculation unit
103 Finger joint recognition unit
105 Processing execution unit
107 Output control unit
109 Wearable device position/orientation estimation unit
111 Inertial integration calculation unit
113 Wearable device position/orientation integration unit
115 Finger joint recognition unit
117 Finger joint recognition unit
119 Finger joint recognition integration unit
121 Inertial integration calculation unit
123 Activation control unit
190 Storage unit
20 Input/output device
201a Imaging unit
201b Imaging unit
201d IR imaging unit
201c IR light source
210 Output unit
211 Display unit
213 Audio output unit
220 Inertial measurement unit
30 Wearable device
301 Imaging unit
302 Imaging unit
303 Inertial measurement unit
310 Output unit
311 Vibration presentation unit
320 Optical Marker
1201 Field of view
1202 Boundary
E1 Central region
E2 Buffer region
E3 Outer region

1. An information processing device comprising:
a control unit configured to control switching of an operation unit to be activated between a first operation unit and a second operation unit related to recognition of a recognition target existing in a real space, on a basis of a detection result of a detection target, wherein
a first sensor configured to obtain first data in which the recognition target is recognized is attached to a first part of a body of a user, and a second sensor configured to obtain second data in which the recognition target is recognized is attached to a second part of the body different from the first part.

2. The information processing device according to claim 1, wherein
the first operation unit includes at least any one of the first sensor or a first recognition unit that recognizes the recognition target on a basis of the first data, and
the second operation unit includes at least any one of the second sensor or a second recognition unit that recognizes the recognition target on a basis of the second data.

3. The information processing device according to claim 1, wherein
the control unit performs control to stop the second operation unit on a basis of a movement of a detection position of the detection target or a prediction position based on the detection position, from an outside of a first region according to a direction of the first part to an inside of a second region according to a direction of the first part.

4. The information processing device according to claim 3, wherein
the control unit performs control to activate the first operation unit on a basis of a movement of the detection position or the prediction position from an outside of the first region to an inside of the second region.

5. The information processing device according to claim 3, wherein
the control unit performs control to activate the first operation unit on a basis of a movement of the detection position or the prediction position from an outside of the first region to an inside a third region that is a region outside the second region in the first region.

6. The information processing device according to claim 3, wherein
the control unit performs control to stop the first operation unit on a basis of a movement of the detection position or the prediction position from an inside of the second region to an outside of the first region.

7. The information processing device according to claim 6, wherein
the control unit performs control to activate the second operation unit on a basis of a movement of the detection position or the prediction position from an inside of the second region to an outside of the first region.

8. The information processing device according to claim 6, wherein
the control unit controls to activate the second operation unit on a basis of a movement of the detection position or the prediction position from an inside of the second region to an inside of a third region that is a region outside the second region in the first region.

9. The information processing device according to claim 2, wherein
the control unit performs control to activate the second operation unit in a case where reliability of recognition of the recognition target by the first recognition unit is lower than a first threshold value or in a case where a relative position/orientation of the detection target as viewed from the first sensor satisfies a first condition.

10. The information processing device according to claim 9, wherein
the control unit performs control to activate the second operation unit, and then performs control to stop the second operation unit in a case where reliability of recognition of the recognition target by the first recognition unit is higher than a second threshold value, or in a case where a relative position/orientation of the detection target as viewed from the first sensor satisfies a second condition.

11. The information processing device according to claim 2, wherein
the control unit performs control to activate a third operation unit in a case where reliability of recognition of the recognition target by the second recognition unit is lower than a third threshold value, in a case where a detection position of the detection target or a prediction position based on the detection position is present outside a first region according to a direction of the first part.

12. The information processing device according to claim 1, wherein
the information processing device includes an output control unit configured to control a display unit to display a virtual object operable by the user, on a basis of a recognition result of the recognition target.

13. The information processing device according to claim 1, wherein
the second sensor is attached to the body at a position closer to the recognition target than the first sensor.

14. The information processing device according to claim 13, wherein
the first sensor is worn on a head,
the second sensor is worn on a predetermined part of an upper limb part, and
the recognition target is a part on a terminal side from the predetermined part in the upper limb part.

15. The information processing device according to claim 1, wherein
the control unit controls the switching on a basis of a detection result of the detection target based on data obtained by at least any of an imaging unit, an inertial measurement unit, a magnetic sensor, or an ultrasonic sensor.

16. The information processing device according to claim 15, wherein
the control unit controls the switching on a basis of a field of view of the imaging unit and a detection result of the detection target.

17. The information processing device according to claim 15, wherein
the control unit controls the switching on a basis of a detection result of the detection target based on data obtained by the imaging unit, and
a direction of the imaging unit changes with a change in a direction of the first sensor.

18. The information processing device according to claim 1, wherein
a position of the recognition target changes with a change in a position of the detection target.

19. An information processing method comprising: controlling, by a processor, switching of an operation unit to be activated between a first operation unit and a second operation unit related to recognition of a recognition target existing in a real space, on a basis of a detection result of a detection target, wherein
a first sensor configured to obtain first data in which the recognition target is recognized is attached to a first part of a body of a user, and a second sensor configured to obtain second data in which the recognition target is recognized is attached to a second part of the body different from the first part.

20. A program for causing a computer to function as an information processing device comprising:
a control unit configured to control switching of an operation unit to be activated between a first operation unit and a second operation unit related to recognition of a recognition target existing in a real space, on a basis of a detection result of a detection target, wherein
a first sensor configured to obtain first data in which the recognition target is recognized is attached to a first part of a body of a user, and a second sensor configured to obtain second data in which the recognition target is recognized is attached to a second part of the body different from the first part.
